(19) United States
(12) Patent Application Publication
(10) Pub. No.: US 2019/0127221 A1
(43) Pub. Date: May 2, 2019

(54) SULFIDES ELECTROLYTE FOR METAL PROCESSING AND EXTRACTION

(71) Applicants: Guillaume Lambotte, Cambridge, MA (US); Sangkwon Lee, Boston, MA (US); Donald R. Sadoway, Cambridge, MA (US); Antoine Allanore, Concord, NH (US); Carole Gadois, Concord, NH (US); Charles Cooper Rinzler, Cambridge, MA (US); Youyang Zhao, Cambridge, MA (US); Katsuhiro Nose, Oita City, Oita (JP)

(72) Inventors: Guillaume Lambotte, Cambridge, MA (US); Sangkwon Lee, Boston, MA (US); Donald R. Sadoway, Cambridge, MA (US); Antoine Allanore, Concord, NH (US); Carole Gadois, Concord, NH (US); Charles Cooper Rinzler, Cambridge, MA (US); Youyang Zhao, Cambridge, MA (US); Katsuhiro Nose, Oita City, Oita (JP)

(21) Appl. No.: 16/302,684

(22) PCT Filed: May 18, 2017
(86) PCT No.: PCT/US2017/033602

§ 371 Date: Nov. 19, 2018

Related U.S. Application Data
(60) Provisional application No. 62/338,950, filed on May 19, 2016.
(60) Provisional application No. 62/415,129, filed on Oct. 31, 2016.

(51) Int. Cl. C01B 17/34; C01B 17/20; C01D 5/00; B01J 39/02; B01J 39/14; B01J 47/14

(52) U.S. Cl. CPC C01B 17/34; C01B 17/20; C01D 5/00; C22F 1/043; B01J 39/14; B01J 47/14; B01J 39/02

(57) ABSTRACT

A method includes contacting a metallic compound comprising a first metallic cation, with a melt comprising a metallic polysulfide comprising a second metallic cation, thereby forming a molten metallic polysulfide of the first metallic cation. The method also includes cooling the melt to form a sulfur phase and a solid phase comprising the molten metallic polysulfide of the first metallic cation.

### CROSS-REFERENCES TO RELATED APPLICATIONS

This application claims priority to U.S. Application No. 62/338,950, filed May 19, 2016, entitled “SULIFIDES ELECTROLYTE FOR METAL PROCESSING AND EXTRACTION,” and U.S. Provisional Application No. 62/415,129, filed Oct. 31, 2016, entitled “SULFIDES ELECTROLYTE FOR METAL PROCESSING AND EXTRADITION,” each of which is hereby incorporated herein by reference in their entirety for all purposes.

### BACKGROUND

Potassium fertilizer is commonly added to improve the yield and quality of plants growing in soils that are lacking an adequate supply of this essential nutrient. Most potassium fertilizer comes from ancient salt deposits located throughout the world. The word “potash” is a general term that most frequently refers to potassium chloride (KCl), but it also applies to all other K-containing fertilizers, such as potassium sulfate (K₂SO₄, commonly referred to as sulfate of potash or SOP).

Today, the main mining sites for K₂SO₄ and other salts are located in the northern hemisphere and costs for transportation make such potassium salts too expensive to be afforded by countries with limited infrastructure or access to the global market. Such reality encourages the use of local potassium-bearing minerals as raw materials for the manufacturing of potassium fertilizers. In particular, K-feldspar containing ores are distributed evenly around the globe and can be mined more easily than potash salts, which usually involves deep underground tunnel mining. One of such rocks is Syenite, which can contain up to 15% wt. of K₂O equivalent as K-feldspar (KAlSi₃O₈).

To date, however, there are no cost-effective technologies to extract the K₂O content and transform it into a salt that can compete with traditional sources. For K-feldspar or any other alkaline-bearing silicates or alumino-silicates, harsh acidic and/or high temperatures are usually used to release the alkali element. For cost and energy consumptions reasons, it is highly desirable to have an alternative medium (also referred to as a solvent) that is less aggressive than these conventional options to release the alkali element.

### SUMMARY

Embodiments of the present invention include apparatus, systems, and methods for metal extraction via ion exchange reactions. In one example, a method includes contacting a metallic compound comprising a first metallic cation, with a melt comprising a metallic polysulfide comprising a second metallic cation, thereby forming a molten metallic polysulfide of the first metallic cation. The method also includes cooling the melt to form a sulfur phase and a solid phase comprising the molten metallic polysulfide of the first metallic cation.

In another example, a method includes contacting a potassium compound comprising a potassium cation, with a melt comprising sodium polysulfide and then cooling the melt to form a sulfur phase and a phase comprising a potassium polysulfide.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a method of metal extraction via ion exchange reaction, according to some embodiments.

FIGS. 2A and 2B illustrate the ion exchange involved in the method illustrated in FIG. 1, according to some embodiments.

FIGS. 3A and 3B schematically illustrate the formation of K₂S₆ in the method illustrated in FIG. 1, according to some embodiments.

FIGS. 4A and 4B are photos showing the red crystals of K₂S₆ found in a sodium sulfide matrix after k-feldspar is immersed in a sodium sulfide/sulfur bath at about 400° C.

FIGS. 5A and 5B are scanning electron microscope (SEM) images of a KFS chunk and elements mapping obtained by energy dispersive X-ray spectroscopy (EDX).

FIG. 6 illustrates a diagram of mass balance to extract 1 kg of potassium from KFS assuming a 100% pure KFS and a full conversion, according to embodiments.

FIG. 7 illustrates selective precipitation of K in the method illustrated in FIG. 1, according to some embodiments.

FIGS. 8A and 8B illustrate selective precipitation of K with 17.5% K, 0% Na, and 82.5% S, according to some embodiments.

FIGS. 9A and 9B illustrate selective precipitation of K with 13% K, 8.5% Na, and 78.5% S, according to some embodiments.

FIGS. 10A and 10B are photos of two crucibles of K—Na-sulfides/sulfur liquid mixtures maintained at 400° C. for 5 hours, quenched, casted in epoxy and cut in half.

FIG. 11 illustrates an example of temperature profile that can be used for the method illustrated in FIG. 1, according to some embodiments.

FIGS. 12A and 12B show ternary diagrams of the feldspar composition and the bath, respectively, at the initial time and after the ion exchange, according to some embodiments.

FIG. 13 shows an Na+S phase diagram.

FIG. 14 shows a K+S phase diagram.

FIGS. 15A and 15B illustrate two possible cooling scenarios for potassium extraction, according to some embodiments.

FIG. 16 shows a zoom of the top part of the Na₂S—K₂S—S ternary diagram shown in FIG. 12B.

FIG. 17 shows concentration of KFS in the intermediate layer at the surface of the KFS particles as a function of time.

FIG. 18 is a chart showing theoretical decomposition potentials for common metal sulfide minerals and supporting electrolyte components.

FIG. 19 shows a cross-section of a molten sulfide electrolysis sample with two graphite electrodes (copper deposition visible at the cathode), according to some embodiments.

FIG. 20 shows a current response to square-wave potential excitation in the sample shown in FIG. 19, according to some embodiments.

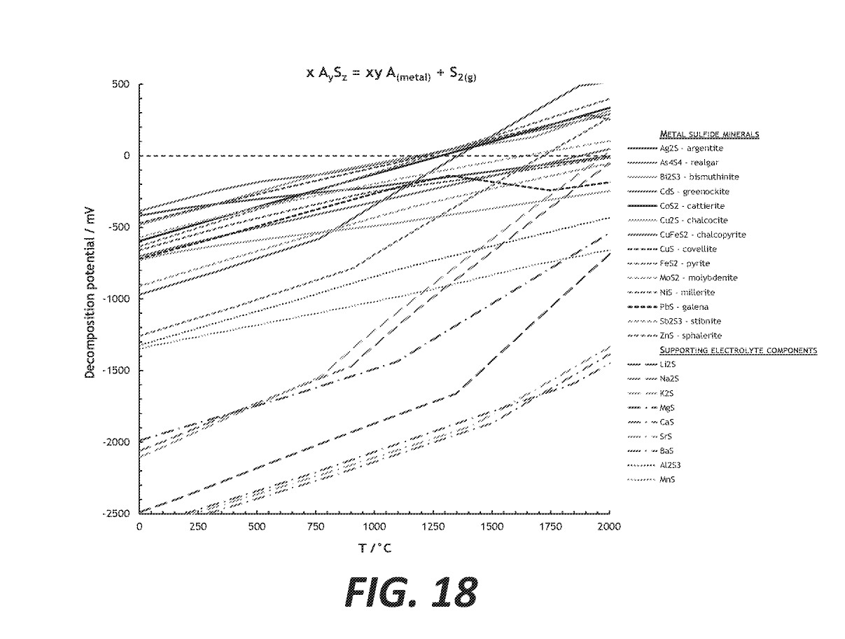

FIG. 21 shows a simplified phase diagram for a Cu₂S—BaS system illustrating copper extraction from BaS—Cu₂S, according to some embodiments.

FIG. 22 shows a schematic of a cell configuration used for copper extraction from BaS—Cu₂S, according to some embodiments.

FIG. 23 is a back-scattered electron image of the cross-section of a solidified electrolyte used for copper extraction, according to some embodiments.

FIG. 24 shows the first cycle of a cyclic voltammogram in molten BaS—Cu₂S at a scan rate of 5 mV·s⁻¹ at 1105° C., according to some embodiments.

FIG. 25 shows DC, fundamental, second, and third harmonic currents measured during AC cyclic voltammetry in molten BaS—Cu₂S at a scan rate of 5 mV19 s—1 at 1105° C., with a sine wave amplitude and frequency at 80 mV and 10 Hz, respectively.

FIG. 26 shows variation of anode and cathode potentials and cell voltage (ΔU) during galvanostatic electrolysis at a cathode current density of 2.5 A cm⁻² during 1 hour.

FIG. 27A shows an optical micrograph of a crucible for copper extraction, according to some embodiments.

FIG. 27B shows an optical image of a cross-section of the cell illustrating the formation of a void due to gas evolution.

FIG. 27C shows an optical image of a droplet of copper recovered in the electrolyte, according to some embodiments.

FIG. 28A shows a BSE image of the electrolyte near the cathode after electrolysis in cross-section, according to some embodiments.

FIG. 28B shows a BSE image of the bulk electrolyte after electrolysis, according to some embodiments.

FIG. 29 shows semiconductor behavior as a function of Pauling electronegativity difference.

FIG. 30 shows evolution of conductivity of semiconducting and metallizing melts as a function of temperature.

FIG. 31 shows degradation of pseudo-gap with increasing temperature in semiconducting melts.

FIG. 32 shows notional phase diagrams of semiconducting and metallizing melts.

FIGS. 33A and 33B show a schematic of a thermoelectric device, according to some embodiments.

### DETAILED DESCRIPTION

Following below are more detailed descriptions of various concepts related to, and embodiments of, inventive systems, methods and apparatus for metal extraction via ion exchange reactions. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

One aspect of the technology aims at selectively separating, sequestrating, and/or recovering a specific metallic element from a mineral phase with limited solubility for the element in traditional solvents, such as aqueous-based solutions. In this aspect, a liquid bath including sulfides and elemental sulfur is employed to extract a metal contained in an insoluble mineral by substitution (also referred to as ion exchange or cationic exchange) with another metal.

For example, the substitution of a metal A, in the form of a cation A^{a+} contained as an oxide in a mineral, is first obtained by an exchange reaction with a metallic cation B^{b+} contained in a mixture of molten sulfide(s) and sulfur, with general formula BₘSₙ/S. The chemical reaction can occur at the interface between the solid mineral and the liquid bath. After the ion exchange, metal A is recovered in the liquid bath in the form of a polysulfide salt of this metal, i.e., AₚS_{q}, while B is incorporated into the mineral forming an oxide of this metal, i.e., BₓO_{y}. This approach is promising to extract metallic elements from insoluble sources such as silicates or alumino-silicates minerals. In particular, the use of a sulfide/sulfur bath as a solvent is attractive because of the potentially low temperature of operation, the relatively low cost, and its ability to phase separation in two liquids or one liquid and one solid with significant density differences. The phase separation also allows a selective and cost effective recovery of one or more phases, along with a good recyclability of the solvent.

The sulfides/sulfur bath acts both as a solvent of extraction for the metal in an oxide and as a carrier of the metallic cation for the ion-exchange. At high concentrations of sulfur, the polysulfides chains Sₙ⁻² can be saturated with sulfur. The sulfur in excess then can form a miscibility gap with the polysulfide chains in which the two liquids are non-miscible. This phenomenon can occur for sodium polysulfides Na₂S and potassium polysulfide K₂S.

In some embodiments, a method of metal extraction includes contacting a metallic compound with a melt. The metallic compound includes a first metallic cation and the melt includes a metallic polysulfide containing a second metallic cation. The contact forms a molten metallic polysulfide of the first metallic cation. The method also includes cooling the melt to form a sulfur phase and a solid phase, and the solid phase includes the molten metallic polysulfide of the first metallic cation.

In some embodiments, the metallic compound is insoluble. For example, the metallic compound can include a metallic silicate. In another example, the metallic compound includes a metallic aluminosilicate (e.g., KAlSi₃O₈, or KAlSiO₄). In yet another example, the metallic compound includes k-feldspar, which can be configured as a chunk or a powder. When configured as a powder, the particle size in the k-feldspar powder can be substantially equal to or less than 2 mm (e.g., about 2 mm, about 1.8 mm, about 1.6 mm, about 1.4 mm, about 1.2 mm, about 1 mm, about 0.8 mm, about 0.6 mm, about 0.4 mm, about 0.2 mm, about 0.1 mm, or less, including any values and sub ranges in between). In yet another example, the metallic compound can include potassium zeolite.

In some embodiments, the metallic polysulfide containing the second metallic cation includes Na₂Sₙ, where n is an integer equal to or greater than 2. In this case, the second metallic cation is the sodium cation (e.g., Na⁺) and the metallic polysulfide containing the first metallic cation is K₂Sₙ, wherein n is greater than 2. For example, the metallic polysulfide containing the first metallic cation can be K₂S₆.

In some embodiments, the method includes further processing of the polysulfide containing the first metallic cation (i.e., the extracted metal compound). For example, when K₂S₆ is produced as the polysulfide containing the first metallic cation, the produced K₂S₆ can be oxidized to produce K₂SO₄, which can be used in agriculture.

In some embodiments, the melt is maintained at a temperature of about 300° C. to about 500° C. during the ion exchange reaction (e.g., about 300° C., about 320° C., about 340° C., about 360° C., about 380° C., about 400° C., about 420° C., about 440° C., about 460° C., about 480° C., or about 500° C., including any values and sub ranges in between). In some embodiments, the melt is maintained at a temperature at a temperature above 500° C.

In some embodiments, the cooling is to a temperature of less than 300° C. (e.g., about 300° C., about 280° C., about 260° C., about 240° C., about 220° C., about 200° C., about 180° C., about 160° C., about 140° C., about 120° C., about 100° C., or less, including any values and sub ranges in between).

In some embodiments, the difference between the ionic radius of the first metallic ion and the ionic radius of the second metallic ion is substantially equal to or less than 25% of the ionic radius of the first metallic ion. For example, the radius difference can be about 25%, about 22%, about 20%, about 18%, about 16%, about 14%, about 12%, about 10%, or less, including any value and sub ranges in between.

In some embodiments, the composition of the melt is within the miscibility gap of the first metallic ion/second metallic ion/sulfur phase diagram.

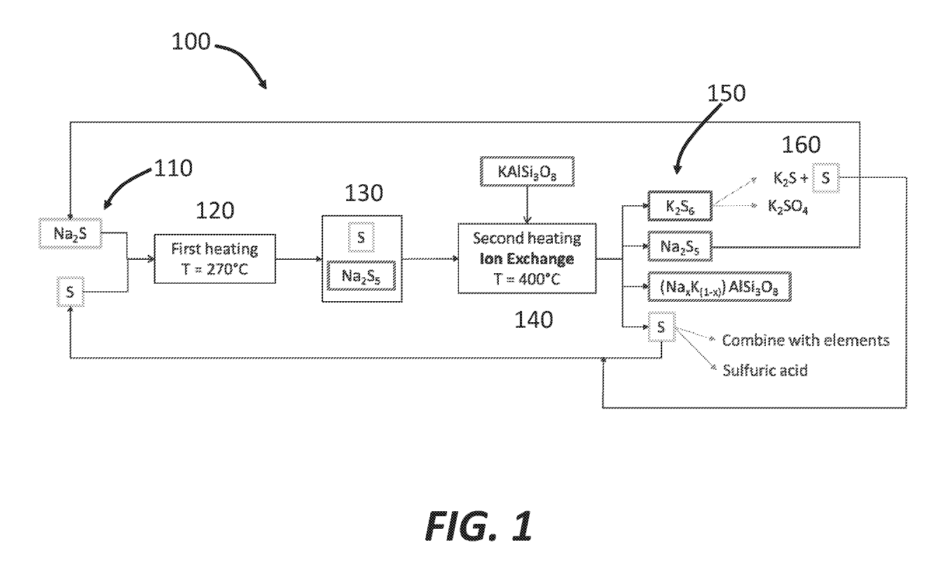

FIG. 1 illustrates a method 100 of extracting potassium from potassium-bearing silicates such as k-feldspars containing KAlSi₃O₈. The melt used in the method 100 includes a molten mixture of sodium polysulfide and sulfur, i.e., Na₂S/S. The potassium is recovered as a soluble potassium sulfide K₂S₆ can be used as a chemical precursor for the synthesis of a traditional potassium fertilizer suitable for crops, K₂SO₄.

In the method 100, Na₂S and S are first mixed to form a melt (also referred to as a sulfides/sulfur bath) at 110. To facilitate the mixing, the mixture of Na₂S and S can be heated at about 270° C. at 120. The heating can generate the melt 130 more suitable for ion exchange reactions to extract potassium. At 140, k-feldspar containing KAlSi₃O₈ is added into the melt and have contact with the Na₂S and S in the melt. The contact can produce K₂S₆, Na₂S₅, (NaₓK₍₁₋ₓ₎)AlSi₃O₈, and S, at 150. As described above, the K₂S₆ can be further oxidized to produce K₂SO₄, K₂S, and S, at 160. The sulfur produced at 150 and/or 160 can be recycled back to 110 to mix with Na₂S and form a melt for further potassium extraction.

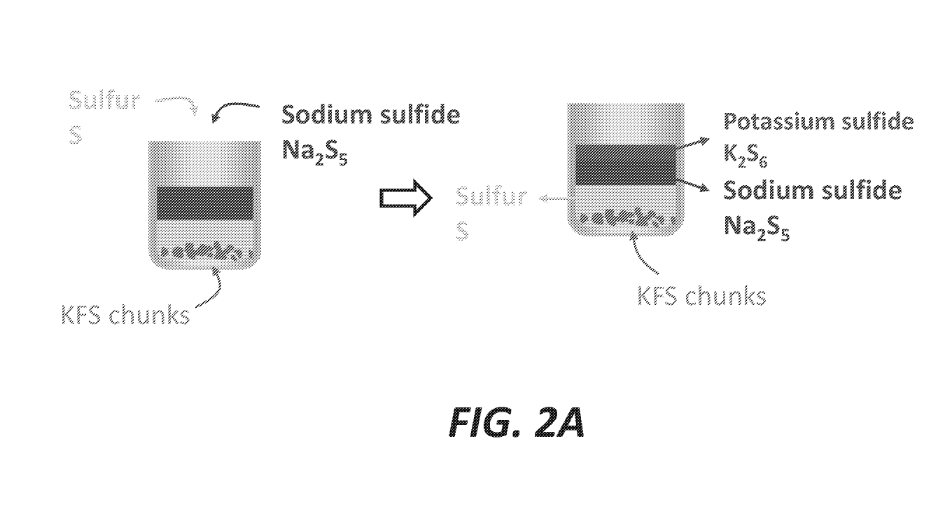

FIGS. 2A and 2B illustrates the ion exchange involved in this method 100. The reaction in the method 100 involves an exchange at the solid-liquid interface. On the solid side, k-feldspar (KFS) has a chemical formula KAlSi₃O₈ and is an aluminosilicate mineral with lattice comprising [SiO₄]⁴⁻ and [AlO₄]⁵⁻ tetrahedra sharing their oxygen atoms. Since Al is trivalent, the lattice carries a negative charge balanced by K⁺ cations which do not occupy fixed positions and are relatively “free” to move with respect to the lattice framework. Therefore, K-feldspar is a crystalline aluminosilicate with cation exchange properties. In contrast, zeolites, which can also be used here and have similar chemical composition, are known for their optimal cation exchange capacities, due to their open structure. KFS, unlike zeolites, have a relatively dense and rigid structure, implying that the cationic exchange occurs at the surface. In some embodiments, as shown in FIG. 2A, k-feldspar can be configured as KFS chunks.

On the liquid side, the mixture of molten sulfur and sodium sulfide (i.e., melt) is used as the solvent carrying the Na⁺ cations and as a recipient for the extracted potassium. The selection of sodium sulfide as the chemical additive is the combination of several favorable factors. First, the efficiency of the ion-exchange can be high because K⁺ and Na⁺ have similar radii and the same electrical charge. Second, Na₂S has a wide availability and is already used industrially for various applications (e.g., pulp and paper, dyes, and leather treatment) at reasonable cost. Third, sulfur also has a wide availability and is already used industrially for various applications and at reasonable cost. Fourth, the presence of sulfur in the final product is an attribute since S is also a useful nutrient for the growth of plants.

In contact with the KFS, the sodium incorporation within the mineral is simultaneously accompanied by the release of a potassium cation in the ionic liquid. In some embodiments, the most stable form of potassium sulfide can be the potassium hexasulfide, leading to the recombination of an S anion with one atom of sulfur to form S₆²⁻. Therefore, the overall reaction can be written as follow:

KAlSi₃O₈½Na₂S₅+^{½}S→NaAlSi₃O₈+^{½}K₂S₆ (1)

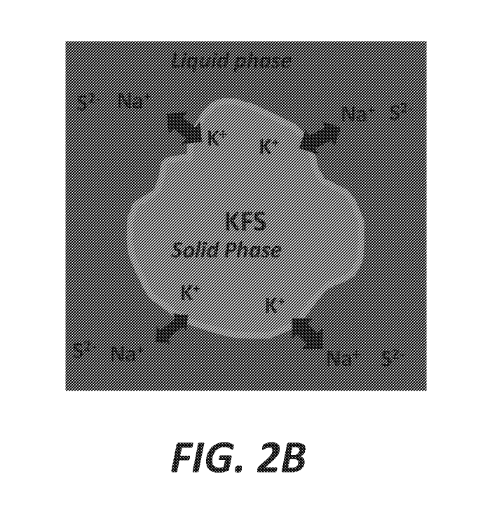

The observation of the samples allows an easy recognition of the present phases, primarily based on their colors. The potassium hexasulfide is very specific with its singular red color and can be readily recognized. FIGS. 3A and 3B schematically illustrate the formation of K₂S₆. In these figures, both Na₂S and KFS are shown in solid phase. The ion exchange reaction produces K₂S₆ within the Na₂S and Na₂S₅ within the KFS. In other words, K⁺ cations enter the Na₂S and Na⁺ cations enter the KFS.

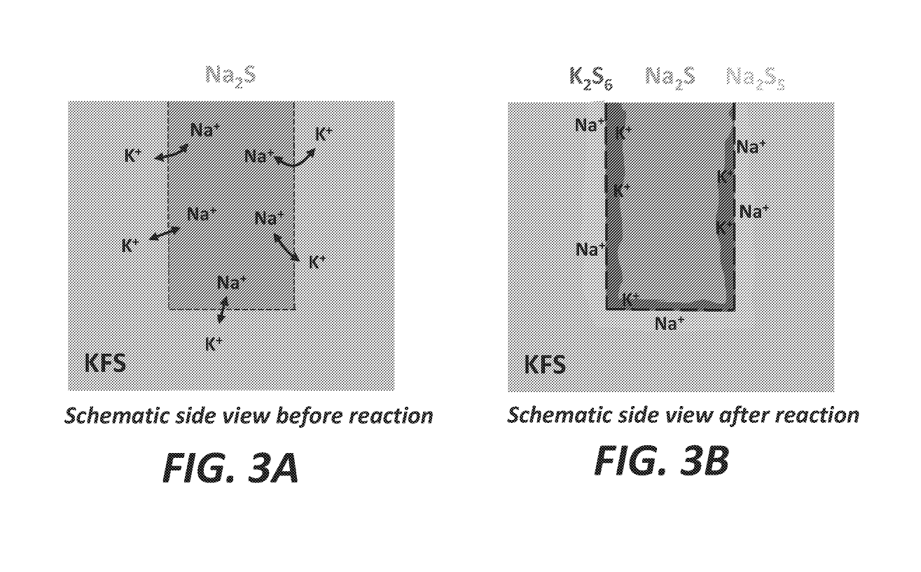

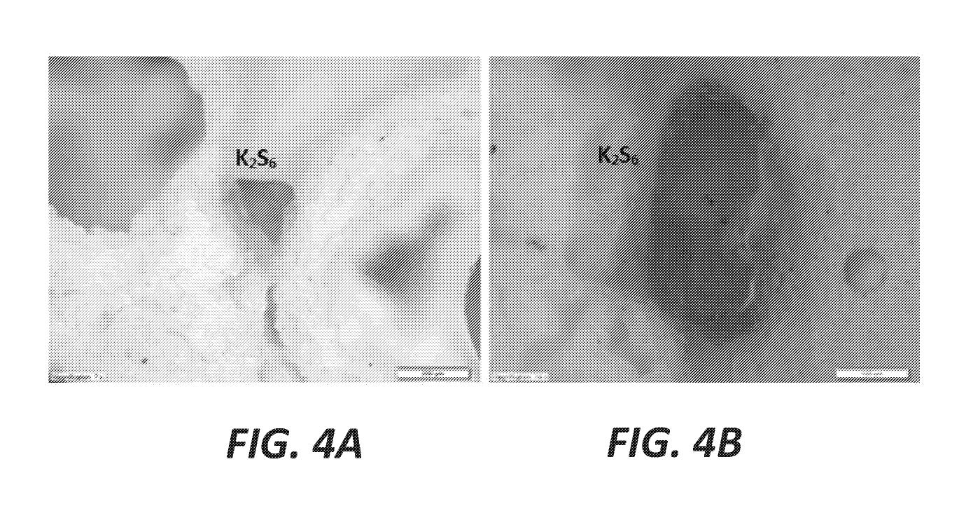

FIGS. 4A and 4B are photos showing the red crystals of K₂S₆ (appearing in pink under the light of the microscope) found in a sodium sulfide matrix, after a 72-experiment of K-feldspar (100 μm) immersed in a sodium sulfide/sulfur bath at about 400° C. FIGS. 5A and 5B are scanning electron microscope (SEM) images of a KFS chunk and elements mapping obtained by energy dispersive X-ray spectroscopy (EDX). SEM image of a particle of 100 μm is shown in FIG. 5A and the corresponding FDX mapping is shown in FIG. 5B. The mapping shows the partial substitution of potassium by sodium at the surface of the particle, in areas where sulfur does not overlap, indicating that most of the observed sodium is not in the sulfide phase anymore, but has rather been incorporated within the aluminosilicate framework to form albite. The results show a promising substitution of K⁺ by Na⁺ in the intermediate layer of at least 50%.

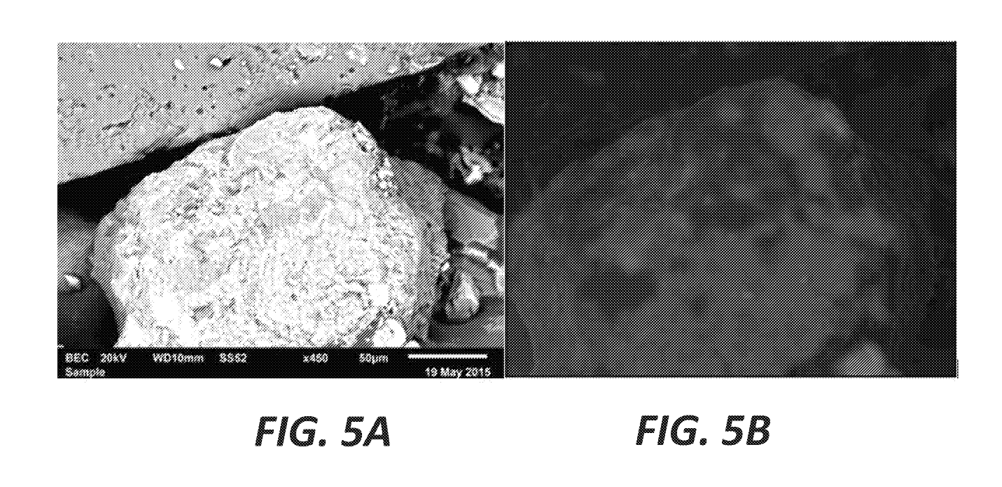

The partial substitution of potassium by sodium leads to the creation of an intermediate phase of sanidine (K, Na-feldspar) at the surface of KFS and the formation of potassium hexasulfide K₂S₆ upon the release of a K cation and a subsequent reaction with sulfur. Assuming an idealistic full conversion of KFS into albite (α=1), the required amounts, added in stoichiometric ratio, to extract 1 kg of potassium from a 100% pure orthoclase can be 7.116 kg of KFS, 0.998 kg of sodium sulfide Na₂S, and 2.050 kg of sulfur. The products of reaction can be 3.460 kg of potassium hexasulfide providing the 1 kg of potassium and 6.704 kg of albite. FIG. 6 illustrates a diagram of mass balance to extract 1 kg of potassium from KFS assuming a 100% pure KFS and a full conversion.

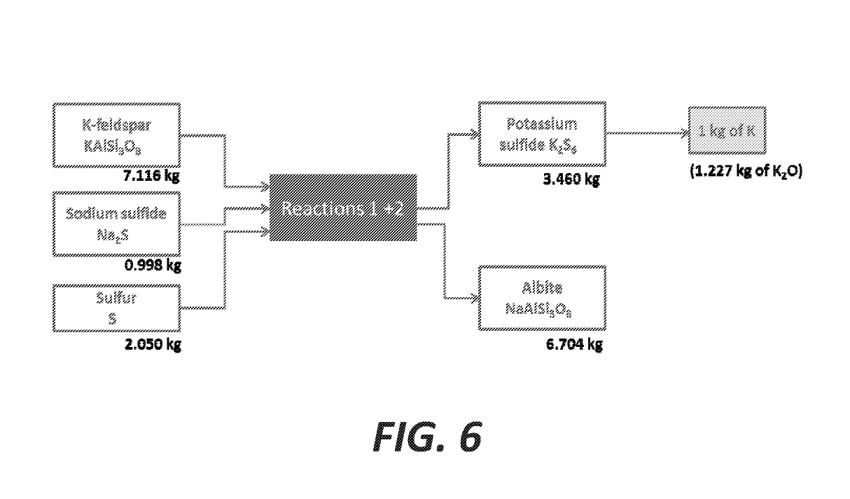

FIG. 7 illustrates the selective precipitation of K in the method 100 illustrated in FIG. 1. Before reaction, the sodium sulfide (e.g., Na₂S), the potassium sulfide (e.g., K₂S) generated from ion exchange, and sulfur (e.g., from the melt) may mix together, rendering it challenging to further process the produced potassium sulfide. After selective precipitation, the sulfur can be located at the bottom, and sodium sulfide can be located on the sulfur, and the potassium sulfide is located at the topmost. In this case, the produced potassium sulfide can be readily

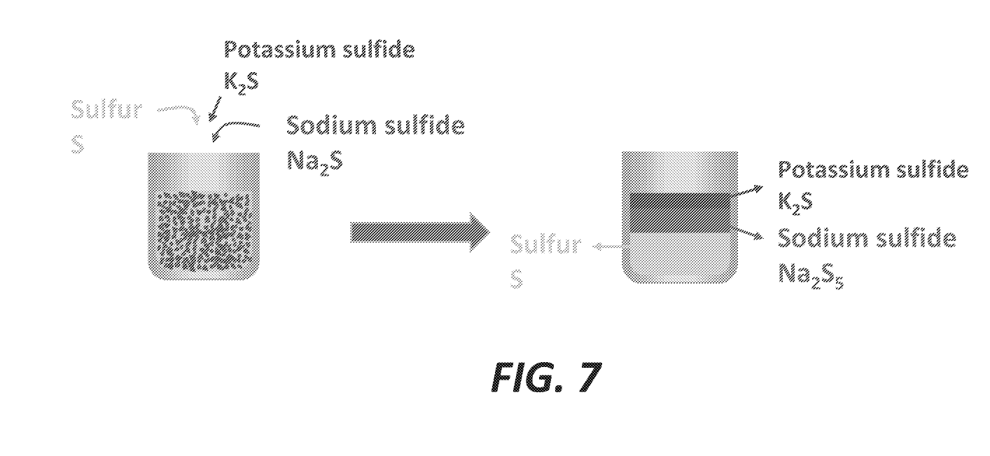

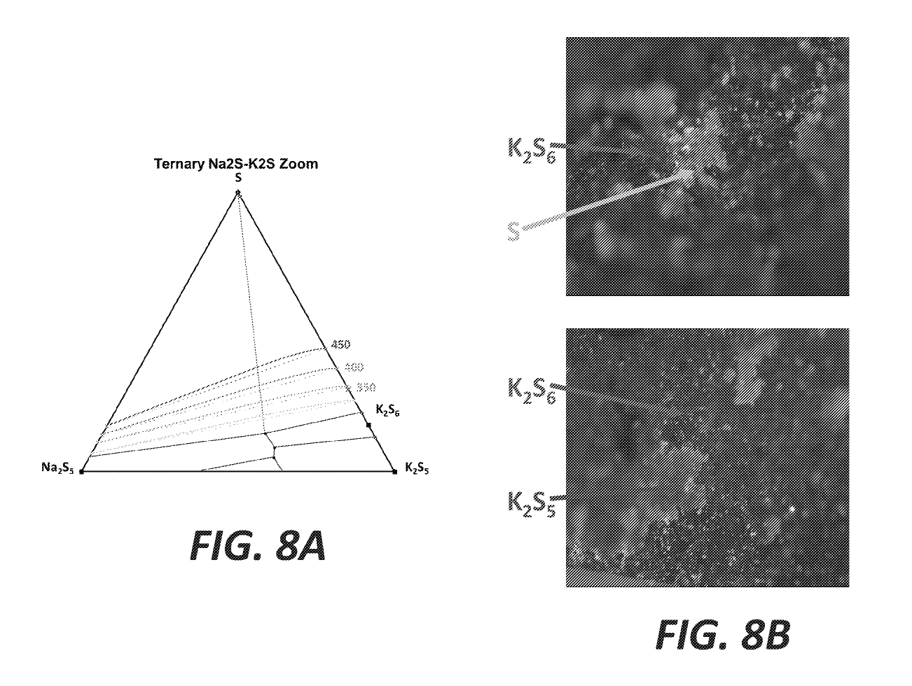

FIG. 8A shows a S/K₂S/Na₂S₅ ternary plot with the following composition: 17.5% K, 0% Na, and 82.5% S. After 2 hours of experiment at about 400° C., the resulting products are shown in FIG. 8B. In the photos, K₂S₆, K₂S₅, and S are observable. FIG. 9A shows a S/K₂S/Na₂S₅ ternary plot with the following composition: 13% K, 8.5% Na, and 78.5% S. After 2 hours of experiment at about 400° C., the resulting products are shown in FIG. 9B. In the photos, Na₂S₄, Na₂S₅, K₂S₆, and S are observable.

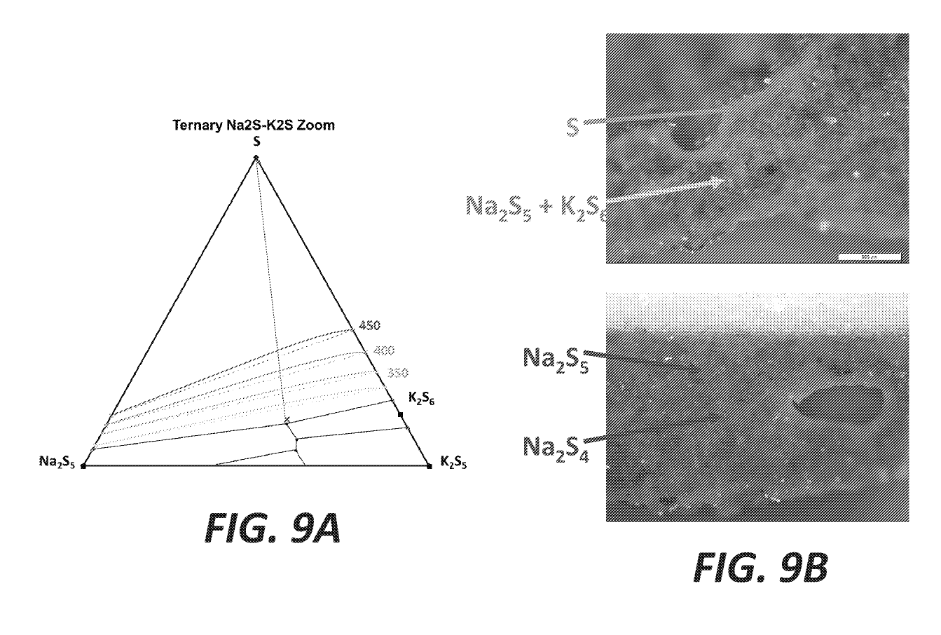

Additionally, some blank tests have been run with different compositions of the baths, below and above the miscibility gap at 400° C., followed by a quenching. FIGS. 10A and 10B show photos of two crucibles of K—Na-sulfides/sulfur liquid mixtures maintained at 400° C. for 5 hours, quenched, casted in epoxy and cut in half. FIG. 10A shows a mixture with composition below the limit of the miscibility gap (1 phase). FIG. 10B shows that the mixture is enriched in sulfur, and its composition lies within the limits of the miscibility gap (2 non-miscible liquids separated based on their densities). As illustrated in FIGS. 10A and 10B, when the remaining amount of sulfur after reaction is too low to end up within the boundaries of the miscibility gap, only one liquid is present and the solid after quenching has a spongy-like appearance (FIG. 10A). The separation between sulfur and sulfide is achieved when the samples have an excess of sulfur (e.g., S-content>90%). In this case, two solids can be obtained: one sulfur phase at the bottom and one sulfide phase above (FIG. 10B).

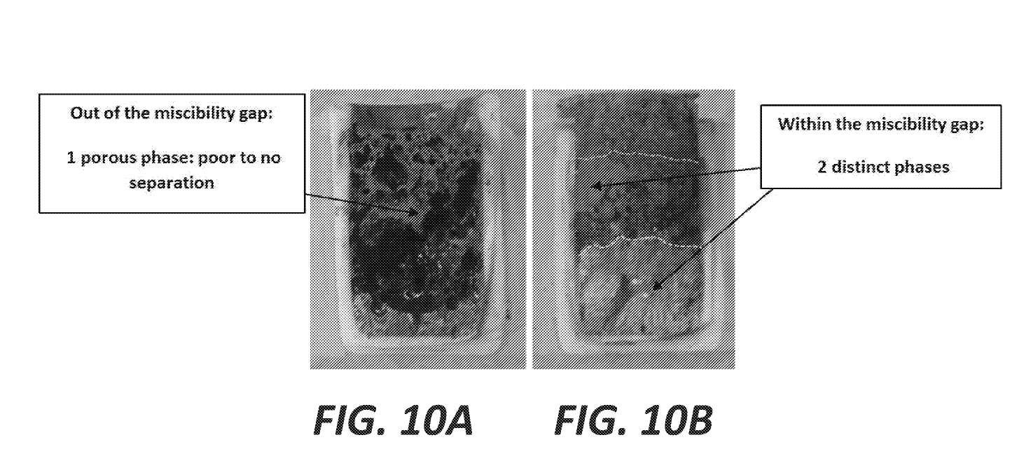

FIG. 11 illustrates an example of temperature profile that can be used for the method 100. In this profile, the temperature can be first increased to about 120° C. for liquefaction of S, and then increased to about 250° C. for liquefaction of Na₂S₅. Then a temperature plateau is set at about 400° C. for the exchange of K⁺ cations and Na⁺ cations and generating potassium sulfide. After this plateau, the temperature is decreased to about 300° C. for phase separation (e.g., to separate sulfur from sulfide). The temperature is further decreased to about 250° C. for precipitation of Na₂S₅. At about 200° C., precipitation of K₂S₆ can occur. Finally, the temperature can be further decreased to about 110° C. for solidification of S.

In short summary, the method 100 illustrated in FIG. 1 can extract potassium from feldspar by cationic exchange with an additive at moderate temperature. The results (FIGS. 2A-11) show that the substitution of K⁺ by Na⁺ is feasible and that the phases of interest could be separated. This separation of the different phases can be achieved based on the several factors. The first factor is the miscibility gap, which allows the separation between the sulfide and the sulfur in excess by a slow cooling (separation by density of two non-miscible liquids). For example, the temperature profile shown in FIG. 11 can be used for the separation. Another factor is the melting temperature valley between the sodium polysulfides and the potassium polysulfides in the S-rich domain (for n>2). This ensures that K₂S₆ and Na₂S₅ phases can be separated by a selective crystallization of the species. This separation can also be controlled by a slow cooling, whereas potassium and sodium sulfides tend to form solid solutions of (Na, K)-sulfides for n<2. A third factor is the difference in densities, allowing the mineral sinking at the bottom, with the sulfur. An overlying layer of sulfides can then be recovered (see, e.g., FIG. 7).

The method described herein has several advantages. First, there is a global availability of syenite rocks containing K-feldspar so the raw materials for this process is abundant. Second, the chemical additives used in the process are inexpensive and can be wastes of the oil and gas industry. In addition, the moderate range of temperatures can be obtained by tailoring the initial composition of the bath, thereby saving power consumption. The efficiency of the K-extraction is also very high, using almost pure K-feldspar and a featured bath's composition. The physical separation of the different created phases can also be readily achieved. For example, sulfides, sulfur, and minerals can be separated. Each phase can be used for future fertilizer applications (e.g., K₂S₆), recycled in the process (e.g., triple eutectic containing Na₂S₅+K₂S₆+S and sulfur), or dismissed without creating hazardous wastes (e.g., sanidine, composed of K-feldspar and albite are already found in the nature). This process can also be implemented in non-aqueous environments and therefore can be used in areas where water resources are scarce.

The methods described herein have various commercial applications. One direct commercial opportunity is to produce K₂S₆ that can later be reoxidized into potassium sulfate (K₂SO₄) for fertilizer. This last compound is a traditional mineral salt used in some specific plants, such as coffee plants, and providing both of potassium and sulfur in a suitable form for the plants' intake. Potassium sulfate is currently advocated by the entire potash industry as the best substitute to the traditional KCI due to its content in S as well as the absence of Cl.

In addition, any industry that seeks to recover an alkaline or alkaline earth element from a silicate or alumino-silicate (or any “insoluble” mineral with cation exchange capacity) is likely to benefit from the methods described herein. For example, the extraction of Lithium for batteries, from lithium-containing igneous rocks (e.g., Spodumene, LiAlSi₂O₆) could be achieved. A similar opportunity is for the processing of beryl general formula (Be₃Al₂Si₆O₁₈) for Beryllium extraction (or any other metal substitute in this general formula). The approach could also be extended to other phases with cation exchange capacity (e.g. radioactive oxides, zeolithes, and clays).

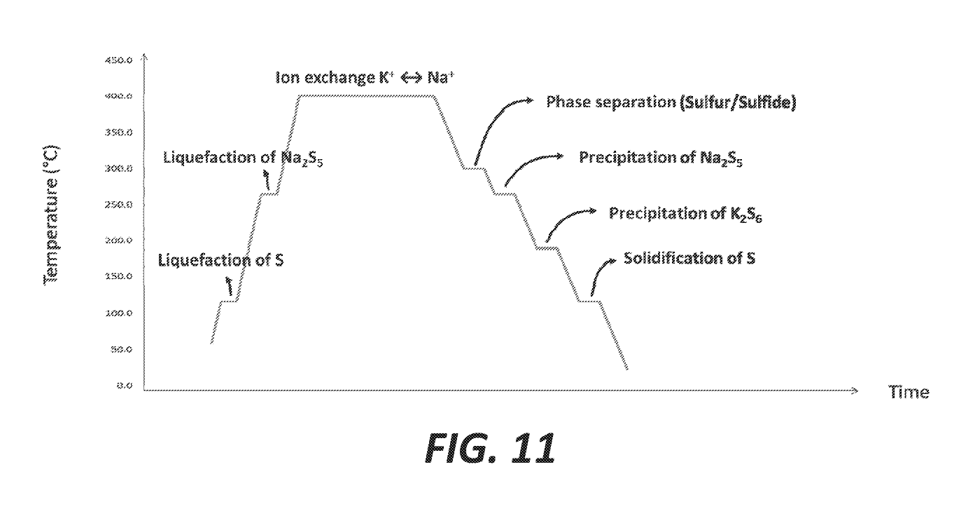

FIGS. 12A and 12B show ternary diagrams of the feldspar composition and the bath, respectively, at the initial time and after the ion exchange (as indicated by arrows). The initial and final compositions depicted here are arbitrary and depend on the raw materials, the initial composition of the bath and the process parameters.

FIGS. 12A and 12B present the composition space for feldspar and the sulfide melt where the ion-exchange reaction occurs, along with the respective reaction paths from initial to final compositions (ideal values). The feldspar minerals (solid) include three end-members phases: K-feldspar KAlSi₃O₈, albite NaAlSi₃O₈, and anorthite CaAl₂Si₂O₈. The grey arrow symbolizes the substitution of K by Na in the intermediate layer of substitution within the mineral, from K feldspar as orthoclase (initial time) toward albitic compositions (after ion exchange).

On the liquid side, the simultaneous K-enrichment/Na-depletion of the bath is symbolized by the grey arrow, shifting from a pure Na—S mixture (indicated by initial time arrow) to a Na—K—S final composition (indicated by after ion exchange arrow), assuming that the sulfur content in the bath remains constant during the reaction. The Na₂S—K₂S—S ternary diagram provides the liquidus lines (locus of melting point).

The understanding of the Na+K+S melt behavior can be helpful to increase the efficiency of the process. The chemical behavior of the molten phases in this system shows a great variety in the whole composition range. Na and K have a low melting point as metals (respectively 97.72° C. and 63.38° C.) while non-hydrated alkali sulfides Na₂S and K₂S have a high melting temperature (respectively 1168° C. and 948° C.). Electrical conductivity measurements show that molten alkali polysulfides have a strong ionic behavior, similar to other molten salts. In the case of polysulfides, unbranched S anions (with n>1), the negative charge is located at each extremity of the chain. It is assumed that molten sulfur exists as S₈-rings or smaller chain units and a de-polymerization occurs upon heating with the addition of alkali metals in the system to form polysullides chains of S₂²⁻, S₃²⁻, S₄²⁻, S₅²⁻ until S₆²⁻. On the other hand, elemental sulfur forms various polymerized compounds in the gas, liquid and solid states.

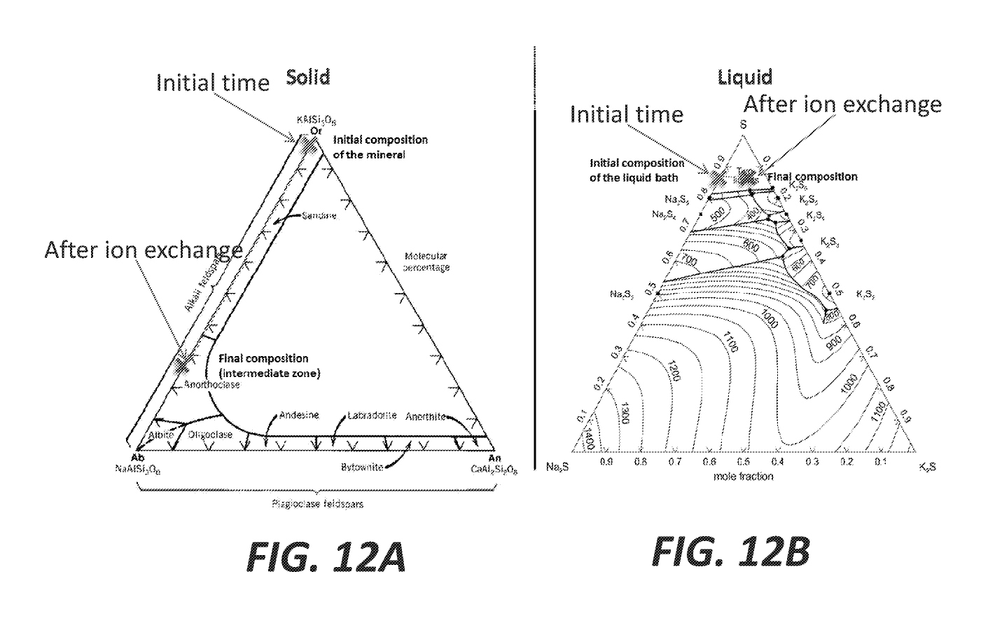

In the molten state, alkaline sulfides can be considered as N⁺ and K⁺ cations in presence of (poly)-sulfide anion Sₙ²⁻. The addition of elemental sulfur to sodium sulfide Na₂S leads to the formation of Na₂Sₙ compounds being liquid at moderate temperatures (e.g., less than 300° C.), depending on the composition of the mixture, as can be seen in the Na+S phase diagram shown in FIG. 13. Those compounds have a relatively low melting temperature with respect to sodium sulfide. The Na—S binary diagram indicates that the liquidus temperature decreases from Na₂S to the eutectic with Na₂S₄ at 61.5 at % of S (240° C.) and the melting points and eutectics of Na₂S₄ and Na₂S₅ lie between 240 to 290° C. Na₂S₅ is the saturated sodium polysulfide. Between the monotectic at 71.2 at. % of S and pure sulfur, a two-liquid region extends to about 600° C.

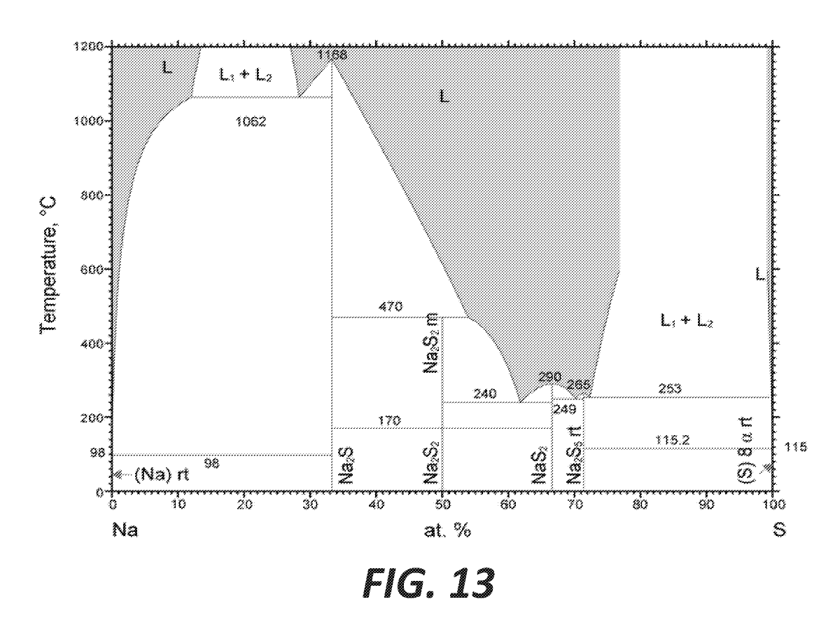

Similarly for the K—S system, as can be seen in K+S phase diagram shown in FIG. 14., the liquidus temperature decreases from K₂S to the eutectic with K₂S₂ (487° C.) and then “sinks” to much lower melting temperatures, where the melting points and eutectics of K₂S₃ to K₂S₆ lie between 120 to 302° C., remarkably lower than for their sodium counterpart. Between the (K₂S₆+S) monotectic at 71.1 at % of S at 183° C. and pure sulfur, a two-liquid region is also present, extending to about 550° C. where potassium hexasulfide K₂S₆ and sulfur are non-miscible, K₂S₆ is the saturated potassium polysulfide.

In the lower part of the ternary diagrams (rich in alkaline), sulfides with n ranging between 1 to 2 tend to form solid solutions of (Naₓ, K₁₋ₓ)25 and (Naₓ, K₁₋ₓ)₂S₂ for which the physical separation between potassium sulfides and sodium sulfides can be challenging. However, based on thermodynamics calculations, no solid solutions may be formed for higher polysulfides (for n>2), where valleys of melting temperature are observed, indicating that the isolation of either Na₂Sₙ or K₂Sₙ is feasible, depending on which “side” of the valley lies the final composition of the liquid. In the case of a bath having an excess in sulfur and having a composition lying in the top part of the ternary diagram, there can be two configurations.

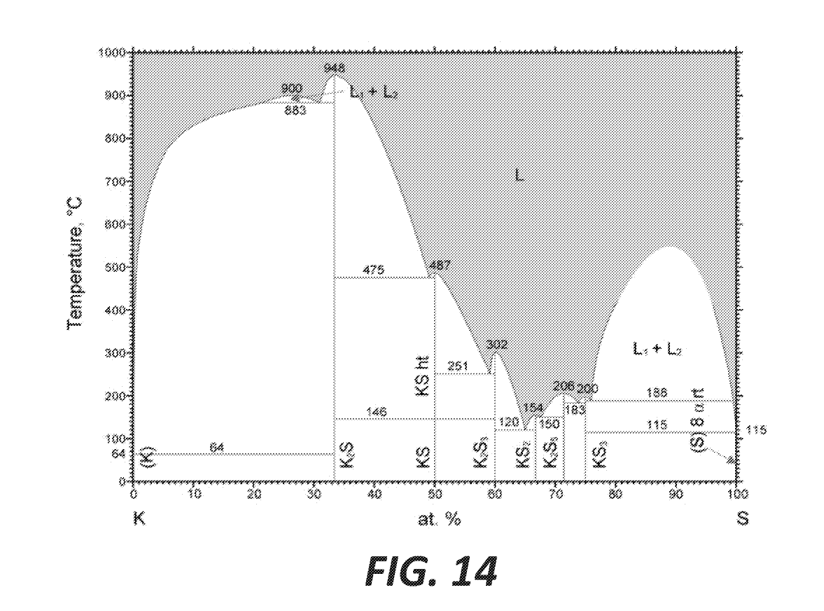

In the first configuration, the final composition is on the left side of the S-E1 line (Na-rich side: see cooling scenario on FIG. 15A): only the selective recovery of Na₂S₅ is possible. Upon cooling, the separation of the sulfur phase and the sulfide phase occurs due to the presence of the miscibility gap. Two liquids are present: almost pure sulfur and the sulfide phase, which composition at point 2 contains Na₂S₅+K₂S₆+S. Then Na₂S₅ solidifies first at 265° C., followed by the solidification of the triple eutectic E1 at 116.6° C. In this case, the potassium extracted from K-feldspar may be embedded in a solid having the composition of the triple eutectic, which is a sodium-rich matrix.

In the second configuration, the final composition is on the right of the S-E1 line (K-rich side: see the cooling scenario on FIG. 15B): the selective recovery of K₂S₆ is possible. Similarly upon cooling, the separation of the sulfur phase and the sulfide phase occurs due to the presence of the miscibility gap. Two liquids are present: almost pure sulfur and the sulfide phase, which composition at point 2 contains K₂S₆+Na₂S₅+S. K₂S₆ solidifies at 189° C., then the solidification of the triple eutectic E1 occurs at 116.6° C. This implies a partial loss of K₂S₆, taking part of the composition of the triple eutectic, but this is nonetheless a practical option for a selective recovery of a pure potassium sulfide phase. The isolation of K₂S₆ is possible when the final composition is shifted away from the triple eutectic point (Na₂S₅+K₂S₆+S) to K—S side of the ternary diagram. This can be achieved by either having a very efficient ion-exchange shifting the bath's composition far to the right, or by initially enriched the initial bath with K₂S₆. In general, the closer the composition is from the K—S side, the smaller amount of K is lost in the eutectic.

After the ion-exchange reaction, a slow cooling is helpful to prevent the quenching of the sulfide/sulfur bath and to allow the density separation of the different phases, thus their recovery. Each phase can later be isolated: the potassium sulfide phase being used for fertilizer application, the triple eutectic and the sulfur can be recycled in the process, while the feldspar being partially transformed into albite can be discarded.

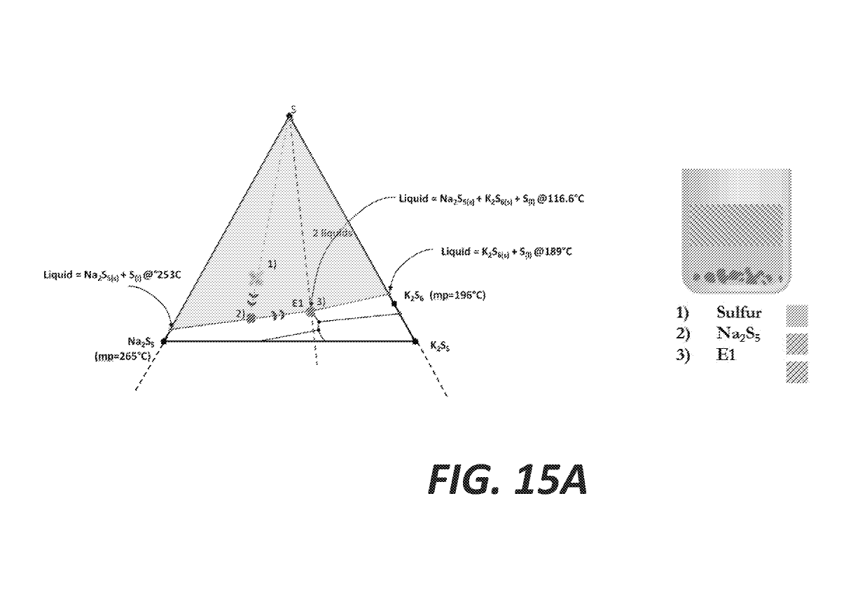

In the upper area of the Na—K—S system, a miscibility gap lies on the sulfur-rich area, where liquid sulfur is not miscible with the sulfide phases (either K- or Na polysulfides). Even though the limits of the miscibility gap are not documented for different temperatures on this diagram, it is observed, based on the Na+S and K—S binary diagrams, that the boundaries are temperature-dependent. FIG. 16 shows a zoom of the top part of the Na₂S—K₂S—S ternary diagram. The pink lines are the projections of the miscibility gap for those temperatures (350, 400 and 450° C.). The two-liquids zones lies above the lines, while a homogeneous liquid is expected “below” the boundaries. The straight dashed lines connect the dots from the Na side to the K-side but it is assumed that the plain lines are more representative of the real behavior of the miscibility gap.

A bi-phased bath in contact with KFS may not be an interesting option since the sulfur phase sinks at the bottom of the crucible, similarly to the KFS powder, being denser than any other phases in the crucible. Consequently, the KFS may not be in contact with the sodium cations located in an upper layer. A temperature increase from 290° C. to 400° C. combined with initial bath composition not too rich in sulfur can ensure that the mixture can be a monophasic liquid and KFS can be in contact with the sodium. At the ion exchange temperature, KFS can be in contact with a monophasic liquid containing the sodium ions: the S-content may not be too high.

Due to the partial volatility of sulfur, it is helpful to control its amount in the reactor during the process in order to avoid significant losses and an impoverishment of sulfur in the final mixture. An excess of S is helpful and the S-content may not be too low either.

A kinetic study is of great interest for assessing a reasonable residence time for this reaction. The intermediate layer is defined as the area where the composition of the initial mineral is modified upon exposure to the sulfur/sulfide melt. The diffusion rate of the alkali cations on a macroscopic scale is dependent on microscopic controlling factors: mechanisms and energetics of ion-migrations. The migration of cations involves a framework relaxation rather than merely a static framework through which ions diffuse. Even though the overall chemical reaction is different than the one carried out before, working with a NaCl bath, the ion-exchange reaction within the feldspar is supposedly the same:

KAlSi₃O₈+Na⁺→NaAlSi₃O₈+K⁺ (2)

Since the recombination of K with the polysulfide anions S occurs in the liquid state, it is assumed that this reaction can happen at a much faster rate than the reaction within the mineral, making the ion-exchange reaction the rate limiting step.

The data have been obtained for a sanidine sample (85% orthoclase, 15% albite) exposed to a 100% NaCl vapor at 850° C. for different periods of time. X_{ab} and Xₒᵣ represent respectively the atomic content of albite and orthoclase within the intermediate layer. The concentration of KFS, [KFS] (in mol/cm³), 1n[KFS] and 1/[KFS] (in cm³/mol) have been calculated and plotted as a function of time in order to determine the kinetic order of the reaction. The linear shape of 1n[KFS] as a function of time is consistent to the fact that the substitution of sodium by potassium within the feldspar is a first-order reaction, where:

$$\frac{- d [ KFS ]}{dt} = k \cdot [ KFS ] \qquad ( 3 )$$

The slope K represents the reaction rate coefficient. Upon integration, the concentration of KFS in the intermediate layer as a function of time can be expressed as:

[KFS]ₜ=[KFS]₀ₑ^{-k} (4)

where [KFS]₀ represents the initial concentration of KFS within the feldspar after a given time. The linear regression gives a coefficient k to be in the order of 0.206 days⁻¹, equivalent to 8.56×10⁻³ h⁻¹.

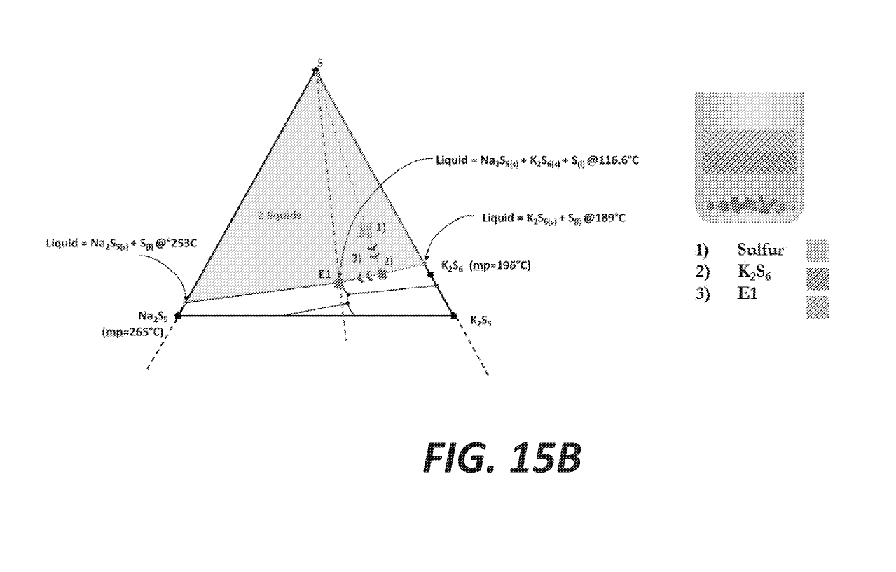

FIG. 17 shows concentration of KFS in the intermediate layer at the surface of the KFS particles as a function of time: 0 to 600 hours on top and zoon on the first 10 hours below, with the expected amount of K-that can be extracted for different purities of the starting materials. The graphs in FIG. 17 also represent the concentration of KFS for different purities of KFS: 100%, 90% and 80% orthoclase at t=0. The second graph is a zoom on the first 10 hours of residence time. This interval is considered as the reasonable range for the residence time.

These graphs show that the amount of potassium that can potentially be extracted from 1 kg of feldspar is significantly higher if the starting material is an almost pure KFS. After 5 hours, 6.05 g of K can be potentially extracted from 1 kg of 100% pure KFS, whereas this amount decreases to 5.45 g and 4.84 g for a K-source containing respectively 90 and 80% of KFS (the balance would be albite in the case of a sanidine mineral). On this section of time, the behavior is almost linear; therefore the amount of potassium extracted is almost doubled if the residence time is extended from 5 hours to 10 hours, regardless of the purity of the starting material.

The kinetics of the ion-exchange depends on the purity of the starting mineral: the A-to-B substitution is faster if the original mineral is rich in A and poor in B. In the particular case of the K-extraction from K-feldspar with a sodium sulfide/sulfur melt, this implies the use of a clean source of K-feldspar having a low content in albite, such as orthoclase minerals (e.g., greater than 95% of KFS and less than 5% of albite) rather than using sanidine (about 85% of KFS and about 15% of albite). The inter diffusion of the cations is kinetically more restricted in the solid side than in the liquid bath but an agitation of the bath could prevent the stagnation of the potassium sulfide at the surface of the mineral and increase the rate of substitution. A faster rate of substitution reduces the residence time, thus the operating costs.

The final A/B ratio in the intermediate layer within the mineral depends on the A/B ratio within the bath. Inter-diffusion depends on the concentration of the ions: any variation in the liquid bath composition modifies the ion-exchange process. At the initial time, the bath's composition is supposedly deprived of A (potassium) and rich in B (sodium) while the feldspar, on the opposite have a low sodium content and is rich in potassium. Thus, the high gradient of concentrations at the solid/liquid interface is the driving force for the ion-exchange.

When 2 objects containing a different ion are put in contact, the concentration of each ion tends to equilibrate in each of these objects (2nd Law of Thermodynamics). This mechanism is activated by the increase of temperature. At equilibrium, the A/B partitioning in the rock is equal to the partitioning within the salt bath:

[A/B]solid=[A/B]_{liquid}@equilibrium

Therefore, controlling the composition of the bath over time is of great interest to move the substitution forward. Specifically for the melt, the sulfide chains can get darker with an increasing length of the sulfide. The evolution of the sulfide chain's length can be visually observed by the color changes of the mixture. Therefore, forming the melt is spontaneous: the sodium sulfide Na₂S reacts with sulfur in excess upon heating to produce Na₂S₅:

Na₂S+4S→Na₂S₅ (5)

The enthalpy calculations suggest that this reaction is exothermic (negative values of enthalpies in the range of −45 to −60 kj/mol). Therefore a potential source of heat can be harvested from this reaction to contribute to lower the needs of energy. This reaction is also spontaneous at the whole range of operating temperatures.

Sulfides minerals are the second most abundant minerals after silicates and are exploited as major economic source of metals such as: copper (from chalcopyrite, CuFeS₂), zinc (from sphalerite, ZnS), lead (from galena, PbS) as well as antimony, arsenic, bismuth, cadmium, cobalt, molybdenum, nickel, rhenium and silver. Gold and platinum group metals are also found associated with these minerals.

The metal is usually recovered from the sulfide ores as follow: mining, mineral processing, flotation separation followed by extractive metallurgy. Two routes are currently available to extract the metal from the concentrate: pyrometallurgy and hydrometallurgy or a combination of the two. These extraction methods have their respective advantages and drawbacks.

The pyrometallurgical treatment involves the formation of SO₂ gas which is toxic and therefore contributes to greenhouse effect and can lead to acid rain if released in the atmosphere. SO₂ gas is usually converted to sulfuric acid at a significant cost and without profits.

The hydrometallurgical process involves the leaching of the sulfide ores to aqueous solution via processes, which are capital intensive and involve a careful and costly treatment and management of water resources. In addition, the final recovery of the metal is obtained via electrowinning from the leachant, and is usually conducted at low current density (0.020 to 0.045 ·cm⁻² for copper), synonymous of low productivity.

In view of the above drawbacks, the direct electrolysis of metal sulfides to produce high purity metal can therefore be a very attractive process by offering a mitigation of emissions (i.e., no or limited production of SOₓ, COₓ or Cl₂), and a reduction of the capital footprint (e.g., by reducing the number of unit-operations in the existing processes). The ability to operate with molten sulfides electrolyte can provide a new versatile extraction method that can benefit commodity metals (copper), as well as strategic, critical or minor metals.

Most of the studies related to the direct electrolysis of metal sulfides involve the use of a molten salt electrolyte (usually halides) and not multicomponent molten sulfides. A major disadvantage of the existing molten salt electrolyte resides in the limited solubility of the metal sulfides feedstock, the need to separate anodic and cathodic compartment, the requirement to prepare the anode prior to electrolysis, and the absence of inert anode for S₂ evolution. Most of the existing techniques also report temperature of operation lower than 1000° C., limiting the ability to make metal in the liquid form and requiring subsequent purification and handling of a powdery material, a requirement that is not practical at the industrial scale.

The approach as described herein directly operate with a multicomponent sulfides chemistry as a supporting electrolyte that operates at high temperature, thereby enabling liquid metal production. This approach develops new sulfide-based electrolytes for the electro-winning of metal directly from their metal sulfides with the production of S_{2(g)}, which can be condensed to solid sulfur. This approach also allows producing liquid metal or alloy.

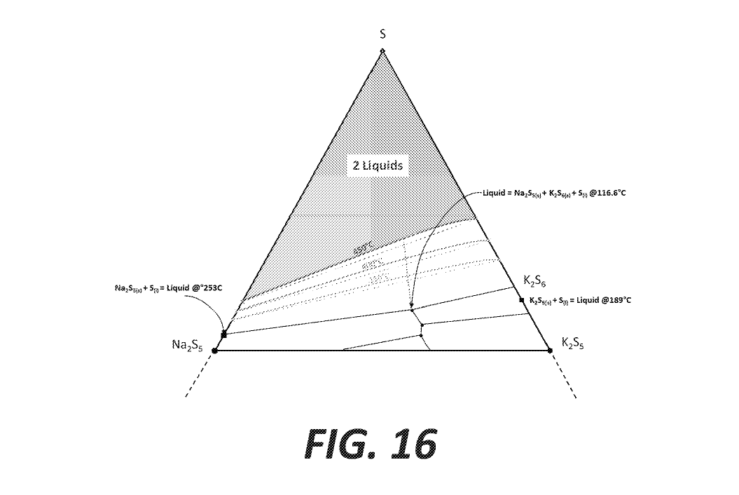

FIG. 18 is a chart showing theoretical decomposition potentials for common metal sulfide minerals and supporting electrolyte components (potential in mV). Based on the calculations shown in FIG. 18, a group of sulfides compounds thermodynamically stable with respect to most common metal sulfide ores and their impurities has been identified: alkaline and alkaline-earth sulfides. Stable additives (e.g. aluminum sulfide) can also be considered in order to modify the properties of the supporting electrolyte, in particular its melting point.

The precise temperature of operation can be dictated by the supporting electrolyte and metal feedstock thermodynamic properties, but a target temperature of 1200° C. is realistic as a first estimate.

Using available thermodynamic data, the energy for sulfides decomposition reaction to metal and sulfur gas can be estimated. Calculations can be performed from room temperature to a target process temperature corresponding to a liquid metal product.

### Copper

Cu₂S_{(s, 25° C.)}→+2 Cu_{(l, 1200° C.)}+0.5 S_{2(g, 1200° C.)}ΔH=2165.0 MJ·t⁻¹=601 kWh·t⁻¹;

Copper from chalcopyrite

CuFeS_{2(s, 25° C.)}→Cu_{(l, 1200° C.)}+FeS_{(l, 1200° C.)}+0.5 S_{2(g, 1200° C.)}ΔH=5104.8 MJ·t⁻¹=1418 kWh·t⁻¹;

### Zinc

ZnS_{(s, 25° C.)}→Zn_{(l, 500° C.)}+0.5 S_{2(g, 500° C.)}ΔH=4565.5 MJ·t⁻¹=1268 kWh·t⁻¹;

### Lead

PbS_{(s, 25° C.)}→Pb_{(l, 500° C.)}+0.5 S_{2(g, 500° C.)}ΔH=914.4 MJ·t⁻¹=254 kWh·t⁻¹;

### Nickel

NiS_{(s, 25° C.)}→Ni_{(l, 1500° C.)}+0.5 S_{2(g, 1500° C.)}ΔH=4198.6 MJ·t⁻¹=1166 kWh·t⁻¹;

These calculations indicate that the electrical energy consumption is likely to be lower than other existing electrowinning processes, in agreement with the relatively low stability of sulfides compounds.

For more realistic estimations, heat losses (e.g., 70%) and a lesser faradaic efficiency (e.g., 40%) can be included to provide more accurate estimated for the electrolysis process energy needs, as listed in Table 1. Despite very conservative estimates for heat losses and faradaic efficiency, a direct molten electrolysis process can still be more energy efficient than current pyrometallurgical and hydrometallurgical processes.

TABLE 1
Energy requirement for producing metal from a sulfide feedstock
(energy in MJ.t⁻¹)

| | Molten sulfide | Current sulfide |
|---|---|---|
| | electrolysis | smelting processes |
| Copper | 5862 | |
| Copper (from | 15961 | 11000 to 18000 |
| chalcopyrite) | | |
| Zinc | 12364 | 30000 to 50000 |
| Lead | 2556 | |
| Nickel | 11956 | |

Sulfides, even in their liquid state, are known to behave as semi-conductors, which imply that a part of the electricity used for the electrolysis is in fact simply conducted through the electrolyte without any electrochemical reaction, consequently lowering the faradaic efficiency of the process. Controlling the physic-chemical properties of the supporting electrolyte, in particular the electronic conduction, appears helpful in order to efficiently extract a metal from its sulfides minerals. However, due to the relatively large difference in electronegativity between the proposed metallic element (e.g., alkaline and alkaline-earth) and sulfur, it is expected that these sulfides may be mainly of ionic nature once molten, thereby promoting ionic over electronic conduction.

The chemical stability of the targeted molten sulfides with respect to the cell materials also need to be taken into account. The alkaline-earth oxides are usually very stable and their corresponding sulfide may not be contained in a cell lined with oxide materials thermodynamically less stable than the alkaline-earth oxides. Very few oxides may be used in this case. Most of the available metals for cell material may react with the molten sulfide electrolyte. Fortunately, graphite is expected to be inert in contact with most of the sulfides.

Similarly the presence of impurities in the feedstock can also be considered. Oxide impurities are expected to have a limited solubility in the molten sulfides and different behaviors are foreseen depending on the thermodynamic stability of the oxide impurities (e.g., solubilizing of the oxides, formation of sulfates, exchange reactions, etc.).

Electrolysis experiments can be conducted in a laboratory setup including a quartz tube furnace under a controlled atmosphere of argon. The molten sulfides electrolyte is contained in a graphite crucible. Two electrodes, also made of graphite, are used for the electrochemical measurements and the electrolysis experiments.

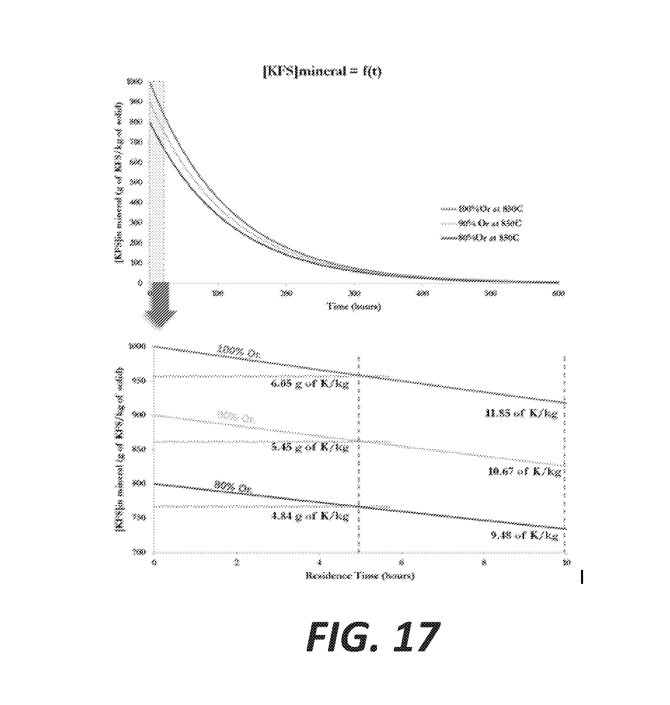

FIG. 19 shows a cross-section of a molten sulfide electrolysis sample with two graphite electrodes (copper deposition visible at the cathode). Chosen compositions for electrolyte candidates have been tested, validating the reported phase equilibrium (liquidus) for these systems as well as the thermodynamic calculations for metal deposition. Preliminary test have been carried out with barium, calcium, and aluminum sulfides as component of the supporting electrolyte. The main purpose of aluminum sulfide is to modify the melting properties of the sulfide electrolyte. In a barium sulfide-rich supporting electrolyte, copper was deposited at the cathode as shown in FIG. 19, whereas in an aluminum sulfide-rich electrolyte, an aluminum-copper alloy was obtained. Barium sulfide being thermodynamically much more stable than copper sulfide, copper deposition was expected. Similarly, the co-deposition of aluminum and copper was not totally excluded in the aluminum sulfide-rich electrolyte.

The metal obtained with the barium sulfide-rich electrolyte is composed on average of 96.4 mole percent of copper and 1.6 mole percent aluminum. In another embodiment, the metal obtained with the barium sulfide-rich electrolyte is composed on average of 96.4 mole percent of copper and 2 mole percent aluminum. The aluminum-copper alloy obtained with the aluminum sulfide-rich electrolyte includes, on average, 58.4 mole percent copper and 41.6 mole percent aluminum. Sulfur was not observed (SEM-EDS analysis) in the alloy, suggesting that the two metals were co-deposited.

In addition, based on the results of stepped-potential chronoamperometry, the possibility to limit the electronic conductivity of a molten sulfides electrolyte can be confirmed, due to tuning the electrolyte composition. The barium, calcium, and aluminum sulfides electrolyte (aluminum sulfide-rich) exhibits 18% of electronic conductivity, a figure that reaches 37% in the presence of copper sulfide. The remarkable number of 4% of electronic conductivity can be achieved by substitution of aluminium sulfide with alkaline sulfide, for example lithium sulfide.

FIG. 3 shows a current response to square-wave potential excitation (potential step: 10 mV). The results obtained with initial experiments need to be further validated and experiments are extended to other possible electrolyte candidates. Some of the questions arise from the experiment include how to control the electronic conductivity, how to predict the impact or behavior of expected impurities (including the oxides and sulfides), whether the S₂ is the only gas species that evolves at the anode, or whether the metal purity is only dependent on the electrochemical reactions or are chemical reactions involved. Additional questions that arise include during the metal production, whether the steady-state metal production is possible and if so, what are the difficulties associated with the removal of sulfur gas from the cell. Other exploratory discoveries can include the cell lining and electrode materials, cell design for optimum temperature and process control. An electrolytic cell can be operated in a non-controlled environment.

Provided an adequate design of the electrolytic cell, sufficient current density and the required electrical conductivity properties, the cell could be self-heated and operated in a similar fashion as an aluminum electrolysis cell. A self-heated reactor implies that the energy requirements for the process are reduced to the electricity used for electrolysis.

The purity of the metal produced by electrolysis of its metal sulfide in molten sulfides can determine if this process is a one step process from sulfide to metal or if a secondary refining process is necessary. Nonetheless the electrolysis approach can remove all the roasting and matte conversion steps from pyro-metallurgical approach and any leaching steps from hydrometallurgical approach, making this approach very attractive. Higher throughput than current processes could be achieved if the operating current density of an industrial-scale electrolytic cell is high enough. Less steps and high throughput implies that the molten sulfide electrolysis can be less capital and space intensive that any current sulfide smelting processes.

The versatility of the targeted molten sulfide electrolytes can enable the processing of different metals in a single reactor. In addition, a precise control of the cell electrochemistry can enable the removal of any impurities less stable than the targeted metal, or their extraction without the co-deposition of more stable impurities.

Another major advantage of a molten sulfide electrolysis process, where the produced S₂ gas is condensed, is the significantly lesser environmental impact due to the absence of SOX and greenhouse gases emissions.

One of the wide potential commercial applications that utilizes a molten sulfide electrolysis process is copper extraction. In 2012, 1.15 million tons were produced by the mining industry in the U.S., valued at 9 billion dollars, the total world mines production being evaluated at 17 million tons. A large part of the produced copper comes from sulfide smelting processes. In addition to copper, critical metals such as molybdenum and rhenium, which are currently by-products of copper extraction, can be more efficiently recovered and valorized.

Productions of zinc and lead in 2012 were valued respectively at 1.53 billion dollars, for 748 million tons produced by U.S. mines, and 0.84 billion dollars, for 345 million tons produced by U.S. mines. World mines production was evaluated at 13 million tons for zinc and 5.2 million tons for lead. Molten sulfide electrolysis would also potentially benefit these two metals mostly produced by sulfides smelting processes.

The potential of this process of sulfide processing can go beyond the primary production of metal and can also allow the synthesis and casting of high purity alloys via their metal sulfides. Such process can also be implemented for tailing processing, recycling processes for chalcophile metals, recovery of metals (from oxide wastes) which oxides are soluble in molten sulfide electrolyte. Another foreseeable use of the develop electrolytes would be for battery electrolyte application where the physico-chemical properties of interest are the same as for electrolysis application.

Sulfide-containing ores are the main raw material for copper extraction. The conventional chemical principle underlying metal extraction from such ore (smelting) is the selective oxidation of sulfide ions (S²⁻) by oxygen. The reaction shown below in Equation (6) forms copper metal and sulfur dioxide (SO₂) as products, as written here for chalcocite (Cu₂S):

Cu₂S+O₂(g)=2Cu+SO₂(g) (6)

Such principle leads to a process characterized by large capital investments and significant environmental challenges. This route involves handling SO₂ as a by-product, typically converted to sulfuric acid. To circumvent this issue, additional pyrometallurgical steps to convert SOₓ into elemental sulfur have been devised, using for example reduction or chlorination.

Hydrometallurgy is an alternative to traditional smelting that does not involve SO₂. It involves a succession of leaching, solvent extraction and finally electro-winning of Cu in an aqueous electrolyte. This route is also characterized by a relatively large footprint and capital cost. One of the limitations is inherited from the electro-winning and/or refining steps, where the current density for copper electrodeposition is typically limited to 0.05 A·cm⁻².

An alternative approach to avoid SO₂ formation is the direct decomposition of copper sulfide into copper and elemental sulfur, following reaction below:

Cu₂S=2Cu+1/2S₂(g) (7)

At 1106° C., more than 20° C. above copper melting point, reaction in Equation (7) is not spontaneous (ΔrG°=90.5 kJ·mol⁻¹) and would require a minimum amount of energy of 267 kJ·mol ⁻¹ (equivalent to 583 kWh·t_{C}_{ᵤ}⁻¹). This reaction can therefore be driven by electricity, as practiced industrially for most metals, including copper and aluminum. In principle, electrolysis can also offer the selective recovery of multiple metals contained in the sulfides ores, for example elements more noble than copper, e.g., silver or molybdenum.

The direct electrolysis of sulfides was proposed in concept by Townsend in a patent in 1906. Since then, the challenge remains in selecting a supporting electrolyte with an acceptable solubility for copper sulfide concentrates to guarantee large cathode current density, a requirement for tonnage production. Previous studies considered both aqueous solutions and halide melts as possible supporting electrolytes.

Conventional aqueous electrolytes have a limited solubility for the concentrate feedstock, and call for harsh leaching conditions in order to be effective at liberating copper ions. An alternative approach is the direct electro-winning of the solid sulfides, for example, using the sulfide as the anode where the sulfide ions are oxidized to form elemental sulfur while the Cu⁺ ions are liberated. Unfortunately, the formation of a non-conductive layer promptly inhibits further reaction at the anode, and hinders further electrolysis. Both approaches have limitations inherited from the production of a solid metal deposit, restricting the productivity of the process.

Therefore, processes operating at a temperature in excess of 1084° C. (the melting point of copper) have been envisioned. Under these conditions, however, the semi-conducting properties of most of the sulfide feedstocks become critical in order to design a satisfactory electrolyte. Electrolysis in molten chloride electrolytes has been demonstrated in 1958, showing remarkable energy efficiency and high current density. Recently, a resurgence in halide-based approach for sulfides electrolysis has been observed for aluminums, tungsten, molybdenum or refining copper. The use of a chloride melt, and CuCl₂ in particular, can suppress the electronic conduction of Cu₂S. However, the low solubility of sulfides in chloride, the sensitivity of such melts to impurities and the limited anodic efficiency due to the competition between sulfur and chlorine evolution from the anode remain key challenges for the molten salt approach.

An alternative strategy is to select molten sulfides as a medium with a high solubility for the sulfide feedstock. Sulfide electrochemical properties have mostly been studied for battery applications, e.g., Li or Na/S batteries. Na/S batteries operate at high temperatures (about 130° C. to about 450° C.), with metallic Na as the active material and β-Al₂O₃ as a separator. The oxidation-reduction processes of sulfur have therefore been investigated in different electrolytes, including sulfide melts, and on different electrodes. Voltammetry indicates that the oxidation of sulfide ions (S²⁻) to elemental sulfur is presumably a single step reaction, while sulfur reduction includes multiple steps leading to the formation of polysulfides of the alkaline metals. The solubility and stability of those species have been reported as a challenge for battery applications. Transport properties such as transference number, diffusion coefficient or conductivity of sodium polysulfides have therefore been studied, revealing that Na⁺ cations are the major charge carrier.

The electrochemical properties of molten sulfides (Na₂S—NiS and Na₂S—FeS) at high temperature have been investigated using voltammetry, in the context of the corrosion of Ni-based alloys in fossil fuels reactors. This study concludes the possibility of a sulfide/polysulfide reaction at the anode based on polarization data and a qualitative evaluation of the possible electron-exchange reactions. There is altogether a need to confirm the suitability of molten sulfides to conduct faradaic reactions, particularly in the context of metal extraction or deposition.

Indeed, most sulfide compounds exhibit metallic or semiconducting behavior in their solid and liquid phases, properties which can be incompatible with the definition of an electrolyte. For example, molten FeS can be a metallic conductor (conductivity of about 1500 ohm⁻¹·cm⁻¹) while molten Cu₂S is a semiconductor. Previous work on the electrolytic decomposition of molten sulfides (mattes) for metal extraction by metallurgists is incomplete and lacks consensus, with some referring to the presence of metallic bonding, while others predicting that Cu₂S dissociates to Cu⁺ and S²⁻ in the melt with S²⁻ ions engaging in weak covalent bonds. It can be a challenge to decompose pure molten Cu₂S, as anticipated from its solid-state bandgap (1.21 eV) and electronic conductivity in the molten state (70 ohm⁻¹·cm⁻¹).

A suitable electrolyte for metal extraction can limit the large electronic conduction inherent in the feed materials. This can be accomplished by adding a species with ionic bonding characteristics. Among sulfides, alkali and alkali earth metals exhibit the largest electronegativity difference vs. sulfur, and presumably exhibit such ionic bonding. Several measurements of the total electrical conductivity of molten sulfides containing Na₂S or K₂S mention a relative suppression of the nonionic behavior of metallic sulfides (i.e. Sb, Sn, Tl, Ag), a conclusion drawn from the drastic increase in the melt resistivity observed upon addition of the alkali sulfide. In the spirit of that reasoning, a single study dedicated to copper extraction by electrolysis from a sulfide is available in the open literature, proposing to operate with a binary Cu₂S—Na₂S. Though not reporting any copper production, this work indicated that the addition of Na₂S lowers the share of electronic conduction of molten Cu₂S.

The first effectual electrolytic production of liquid copper is demonstrated from copper (I) sulfide (Cu₂S) in a binary sulfide electrolyte, using BaS as the additional electrolyte constituent.

The solid-state properties of BaS are indicative of a partial ionic nature: it exhibits a relatively large electronegativity difference on the Pauling scale (1.69 vs. 2.23 for NaCl ), a large bandgap (3.92 eV vs. 1.21 eV for Cu₂S), and a small electrical conductivity (0.01 ohm⁻¹·cm⁻¹ vs. 70 ohm⁻¹·cm⁻¹ for Cu₂S). Consequently, the electrical behavior of the binary BaS—Cu₂S can exhibit a non-negligible share of ionic conduction depending on the composition and the temperature. Independent of such static condensed matter considerations, which ignore the role of transport phenomena and faradaic reactions, the question of the electrolytic performance of such a melt for metal extraction, particularly in terms of cathode faradaic efficiency, remains open.

Herein, the findings related to the direct electrolysis of one composition in the binary BaS—Cu₂S at 1105° C. are reported. The techniques described herein provide a first insight into the underlying cathodic electrochemical reactions via DC and AC voltammetry. The results of galvanostatic experiments are also described, confirming the extraction of liquid copper from a molten sulfide melt

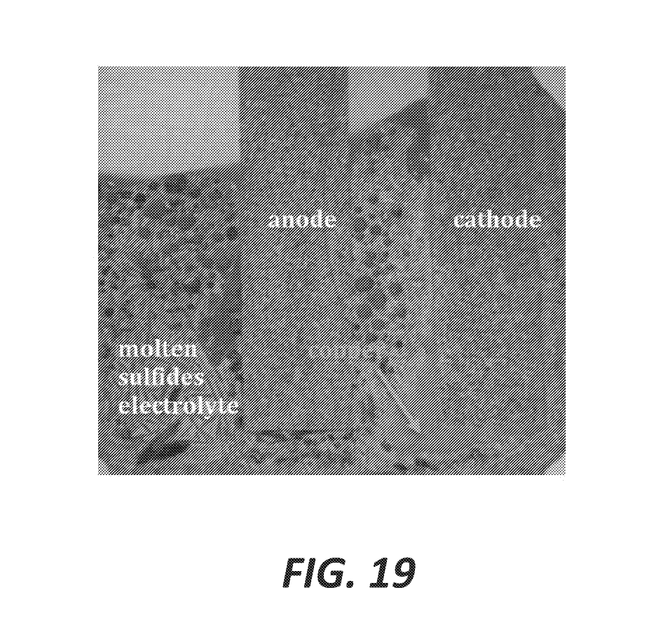

The working temperature for the electrochemical measurements was selected to be more than 20° C. above the melting point of copper, at 1105° C., to ensure liquid metal production. The electrolyte composition was chosen from the reported BaS—Cu₂S phase diagram reproduced in FIG. 21, in which the circles correspond to the reported transition points, the dashed line indicates the operating temperature selected in the present work and the cross represents the electrolyte composition.

In FIG. 21, a homogenous liquid is expected to form at 44.7 mol % Cu₂S (43.2 wt %) and 55.3 mol % BaS (56.8 wt %). The liquidus drawn in the BaS-rich side of the diagram (dash line) is a graphical extrapolation to the reported melting point of BaS, since there are no experimental data available. Barium and copper (I) sulfides (BaS, 99.7%, Cu₂S, 99.5% metals basis, Alfa Aesar) powders were mixed in a polystyrene dish, starting with the former (55.3 mol % BaS and 44.7 mol % Cu₂S). The powders were mixed with a stainless steel spatula, and the mixture was transferred to a graphite crucible (less than 50 ppm ash content) of 14.5 mm inner diameter and 25.4 mm depth. The crucible was placed in a fused quartz tube (e.g., from Technical Glass Products, Inc.) and heated under argon (e.g., 99.999% purity min.) atmosphere with a tube furnace (e.g., from Lindberg/Blue 26 M Mini-Mite). The furnace temperature was maintained at 200° C. for 1 hour with argon flow at 20 mL·min⁻¹ to remove moisture. The temperature was then increased at 17.5° C.·min⁻¹ to the set point of 1105° C., with a minimal flow of argon (<1 mL·min⁻¹). This temperature was held for 3 hours. After furnace shutdown, the time-averaged cooling rate was 18° C.·min⁻¹ under argon flow at 40 mL·min⁻¹ until a temperature of around 600° C. The weight loss during this procedure was less than 2%.

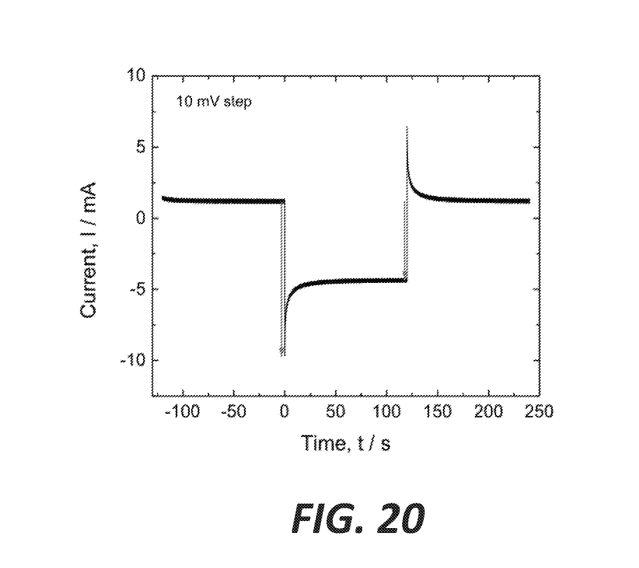

FIG. 22 shows a schematic of a cell configuration 2200 used for copper extraction from BaS—Cu₂S, according to some embodiments. The cell 2200 includes molten electrolyte 2210 contained in an Al₂O₃ tube, which in turn is enclosed in graphite 2230. The cell 2200 also includes 2240, which can be made of stainless steel.

In one example, Graphite rods of 38.1 mm length (e.g., 99.9995% purity, from Alfa Aesar) and of 3.05 mm and 1.76 mm diameter were used as counter and pseudo-reference electrodes, respectively. The working electrode was a graphite rod of 2.4 mm diameter embedded in an alumina tube of 4 mm outer diameter, which served as a sheath. The corresponding exposed geometrical area was then 0.045 cm². Molybdenum wires were used as current lead to the graphite electrodes.

Different electrode configurations can be used for different measurements. For the electrochemical measurements (DC & AC voltammetry), the electrodes can be moveable in the z-direction and configured in triangle at the top of the crucible, immersed at the top of the electrolyte. For galvanostatic measurements, the working and reference electrodes can be fixed and located at the bottom of the crucible, and the anode can be tubular (e.g., OD 6.57 mm, ID 4.85 mm and 50 mm length).

In order to control the current path between the anode and the cathode, the outer surface of the former was protected with an alumina tube (98 wt % purity). The electrical connection to the anode was a threaded stainless steel tube. The corresponding anode area is about 0.92 cm² assuming the inner tube walls are electrochemically active (e.g., immersion 5 mm). More realistically, and according to the primary current distribution, only the horizontal ring facing the cathode is electrochemically active, leading to an area of 0.15 cm². This configuration, as shown in FIG. 22, proved to facilitate the escape of the gas from the anode surface, despite leading to an anode current density around 10 times smaller than the cathode.

The electrodes and the graphite crucible containing the electrolyte were placed in a quartz tube purged with argon at 20 mL·min⁻¹. The heating procedure described herein was also followed in this step, and the temperature was held for 1 hour at 1105° C. before inserting the moveable electrodes into the melt and conducting electrochemical measurements. The electrodes were immersed into the bath until electrical contact was achieved. The immersion depth of the anode was about 5 mm. Conducting this procedure without applying electrochemical signals did not cause the formation of metallic copper, pointing to the thermodynamic stability of copper sulfide in the selected melt in presence of the electrode/crucible assembly under the operating conditions.

Open circuit potential (OCP), direct-current (DC) cyclic voltammetry, impedance spectroscopy at OCP, and galvanostatic electrolysis measurements were all conducted with the same potentiostat/galvanostat (e.g., Reference 3000, Gamry). For alternating-current (AC) voltammetry measurements, a sine wave of fixed amplitude and frequency generated by a 24 bit digital-to-analog audio interface (e.g., UltraLite-mk3 Hybrid, Motu) was superimposed onto the DC potential ramp. Analog potential and current responses were collected at the outlets of the potentiostat at a sampling rate of 20,000 samples per second using an analog-to-digital data acquisition system (e.g., DT9837, Data Translation). All signal processing, such as Fourier and inverse Fourier transform, was performed using a Lab View code.

Potentials in this work are referred to the graphite pseudo-reference and corrected post measurements by 60% of the ohmic resistance measured between the working and reference electrodes at OCP using impedance spectroscopy. The anode, cathode and cell potential during the galvanostatic measurements were recorded using an Omega data acquisition system (e.g., OMB-DAQ-54).

Samples were stored in a controlled atmosphere storage cabinet before further analysis and characterization. After the experiment, the ensemble composed of the crucible, the electrodes and the electrolyte was mounted in epoxy resin (e.g., EpoKwick, Buehler) and cured in air for 24 hours. After cleaving using a hacksaw, the sample was ground with silicon carbide papers (e.g., grit up to 1200) using Kerosene as a lubricant, and polished up to 1 μm using a diamond solution. Observations were conducted with optical (e.g., Olympus BX51, Olympus) and scanning electron microscopes (e.g., JEOL JSM-6610LV, JEOL Ltd.). The SEM was equipped with energy dispersive spectroscopy (e.g., EDS, Sirius SD detector, SGX Sensortech Ltd.) for elemental analysis. Compositions were occasionally confirmed with wavelength dispersive spectroscopy (e.g., JEOL JXA-8200 Superprobe).

Faradaic efficiency estimates are calculated from the weight of copper recovered. The copper droplets were collected from the electrolyte after electrolysis. The attached electrolyte was removed using a stainless steel tweezer. The weight of the deposited copper was measured using a scale (e.g., Sartorius, 0.001 g accuracy), and compared with the prediction from Faraday's law, assuming a one-electron transfer process.

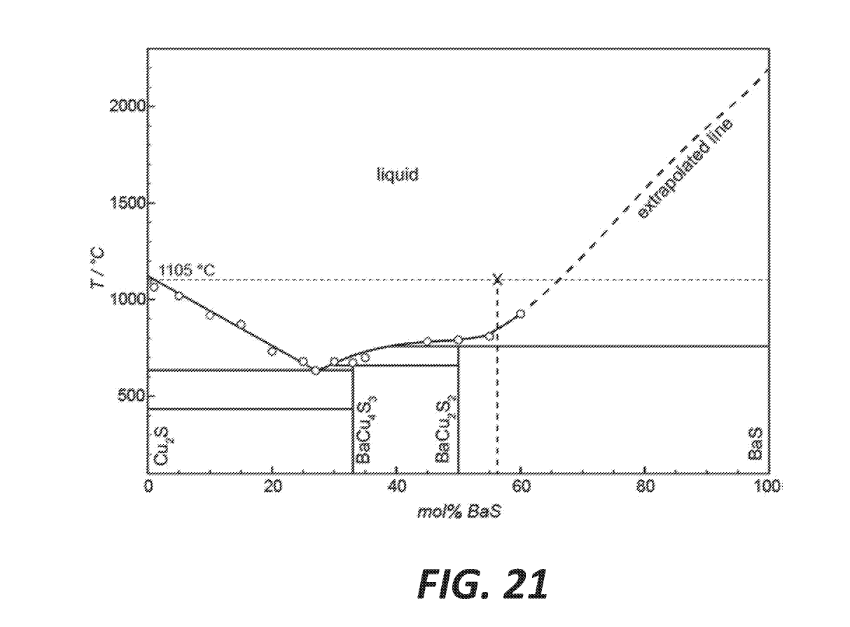

FIG. 23 is a back-scattered electron image of a cross-section of the solidified electrolyte after preparation, obtained following the procedure described above. Three solidified phases are distinguishable, labeled BaS, BaCu₂S, and BaCu₄S₃ according to the phase diagram and the results of wavelength dispersive X-ray spectroscopy (WDS). The microstructure follows qualitatively what is expected from the phase-diagram and a quasi-equilibrium solidification: a minute amount of BaS solidifies first. This event leads to the rejection of Cu₂S, leading to the formation of Cu₂S-rich compounds of lower melting point, in an amount which increases with their decreasing BaS content.

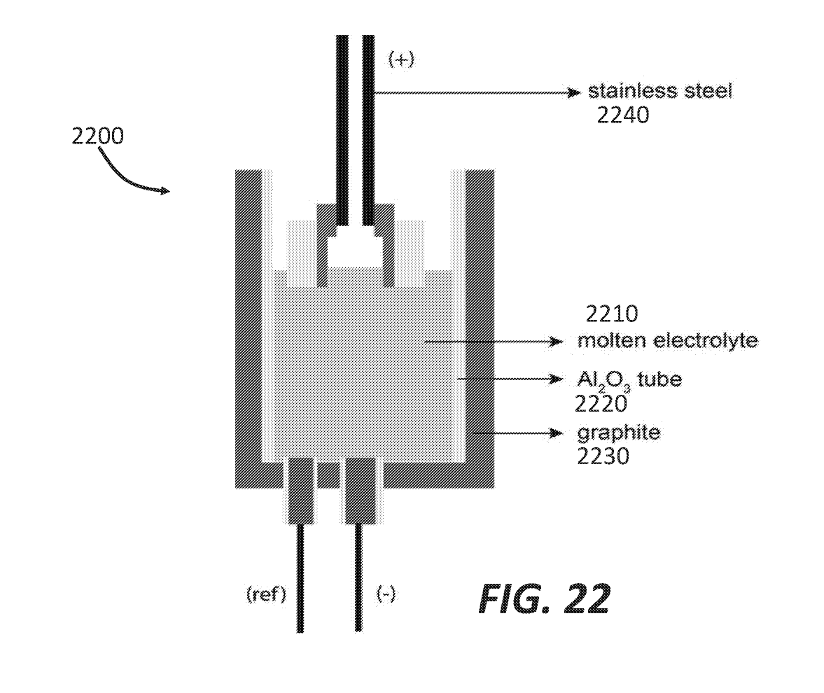

The feasibility of conducting faradaic reactions in this melt was investigated using both direct (DC) and alternating current (AC) electrochemical techniques. FIG. 24 shows the first cycle of a cyclic voltammogram in molten BaS—Cu₂S at a scan rate of 5 mV·s⁻¹ at 1105° C., starting polarization in the negative direction from the open circuit potential (about −0.3 mV vs. graphite). The labels C and A represent the cathodic current plateau and the anodic wall, respectively. In FIG. 24, a DC cyclic voltammogram is recorded on the graphite working electrode, where a current plateau at 4 A·cm⁻² (label C) is observed until around −0.185 V/ref, after which the current further decreases. The anodic portion of the sweep exhibits a monotonic current increase, with steep increase at around 0.19 V/ref. Measurements at a scan-rate higher than 5 mV·s⁻¹ did not reveal any distinctive features in this electrolyte and cell configuration. Fourier transformed (FT) AC voltammetry was conducted to isolate the relative contribution of faradaic and non-faradaic currents (e.g., double layer or adsorption phenomena) using second and higher harmonics.

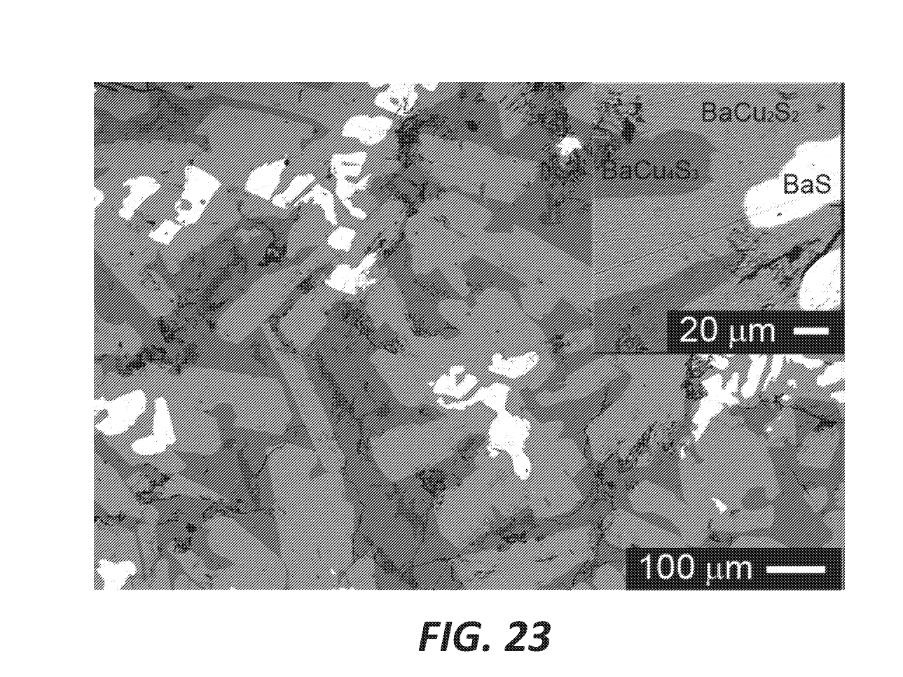

FIG. 25 shows DC, fundamental, second, and third harmonic currents measured during AC cyclic voltammetry at a scan rate of 5 mV·s⁻¹ at 1105° C., with a sine wave amplitude and frequency at 80 mV and 10 Hz, respectively. E1 and E2 represent the potential at peak current in the fundamental harmonic and the half wave potential in the 2nd and 3rd harmonics, respectively. Band selection is about 0 to about 1 Hz for the DC component, 10±1 Hz, 20±0.1 Hz, and 30±0.09 Hz, for the 1st to 3th harmonics, respectively. DC and AC components are distinguishable from the power spectrum, and the appropriate band selection for the inverse Fourier transformation provides their respective components in the time domain, presented in FIG. 25. The DC component reproduces the DC voltammogram of FIG. 24, confirming that the AC perturbation did not affect the DC phenomena. Second and higher order harmonics confirm the occurrence of a faradaic reaction with a half-wave potential (E₂) between −0.014 and −0.019 V/ref. The first harmonic measured during the forward scan exhibits a peak potential (Ei) more anodic than E₂. This anodic offset of E1 is not observed in the subsequent scans.

Galvanostatic electrolysis experiments have been performed to verify the production of liquid copper in accordance with reaction shown in Equation (7). Preliminary experiments showed a large variability in the measured faradaic efficiency, often limited to 5%, which was attributed to the back reaction between the anodic (S₂) and cathodic (Cu) products as well as difficulty in recovering a single copper droplet. These issues have been partly addressed by a careful redesign of the electrochemical cell.

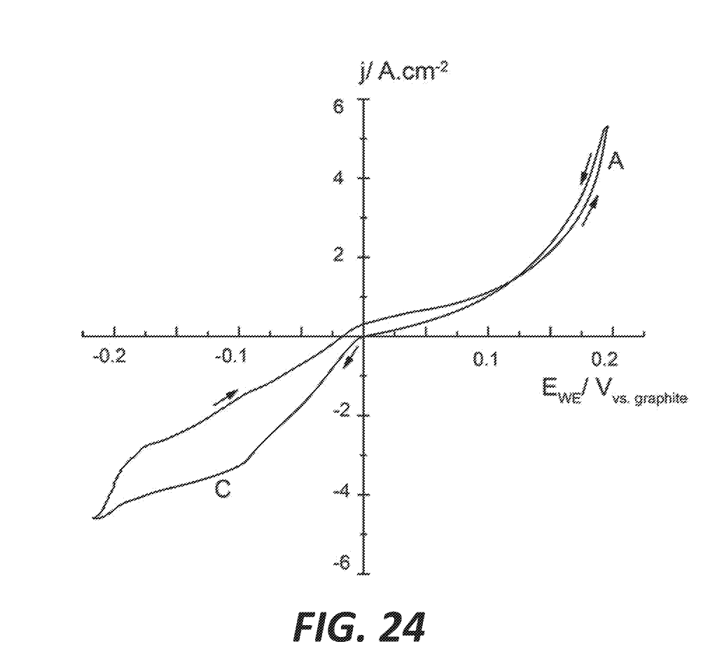

FIG. 26 shows variation of the anode and cathode potentials and cell voltage (ΔU) during galvanostatic electrolysis at a cathode current density of 2.5 A cm⁻² during 1 hour. The plain lines are drawn to guide the eyes, and the gray lines present the raw data. Dashed line represent different electrolysis period (data not shown), and the numbers in percent the estimated current efficiency. The corresponding anode density is around 0.25 A·cm⁻². The measured cell voltage matches the thermodynamic prediction using the Nernst equation for reaction 2, with a minimum cell voltage of 0.480 V at 1105° C. and a partial pressure of S₂ at 2.0×10⁻⁷ atm. The variation of the cell voltage during electrolysis follows those of the cathode potential, while the anode potential is relatively constant.

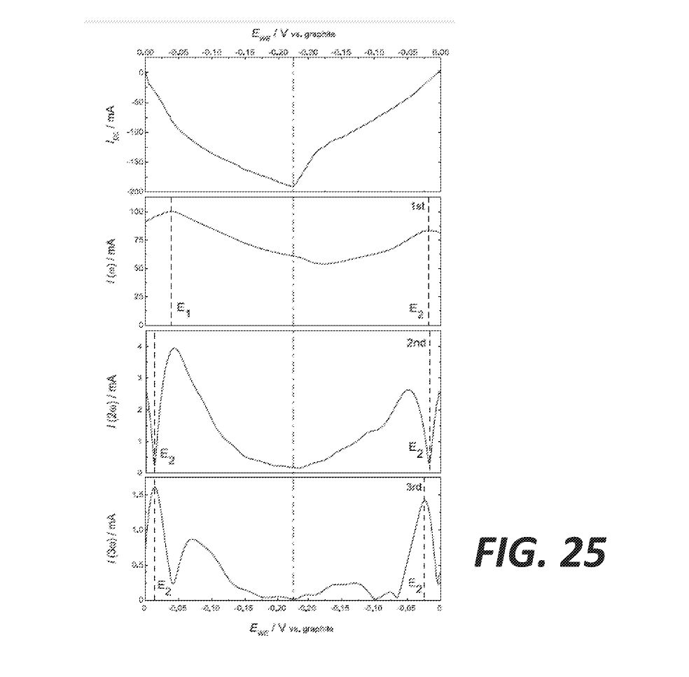

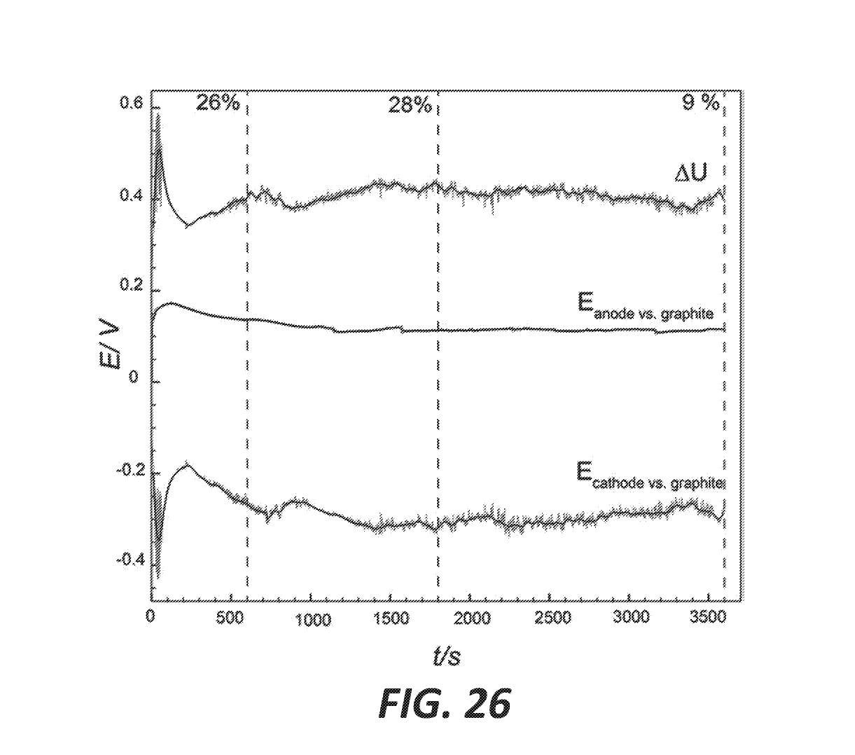

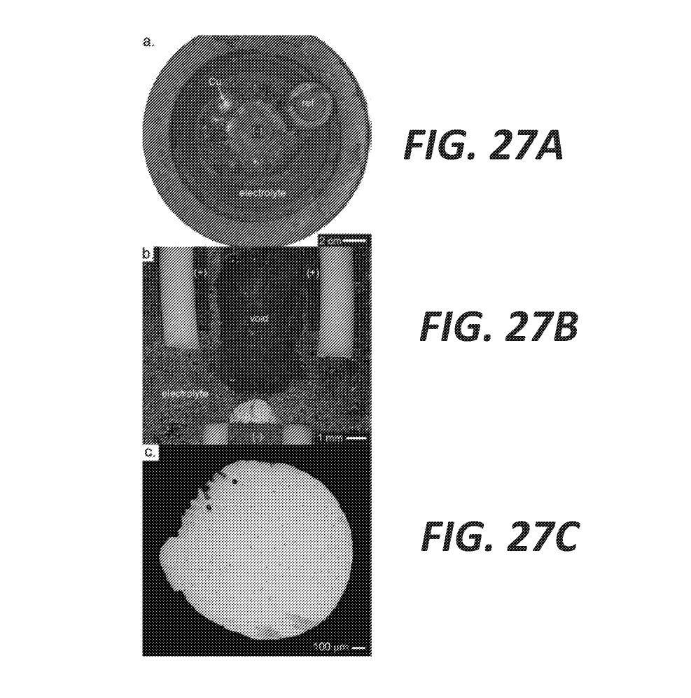

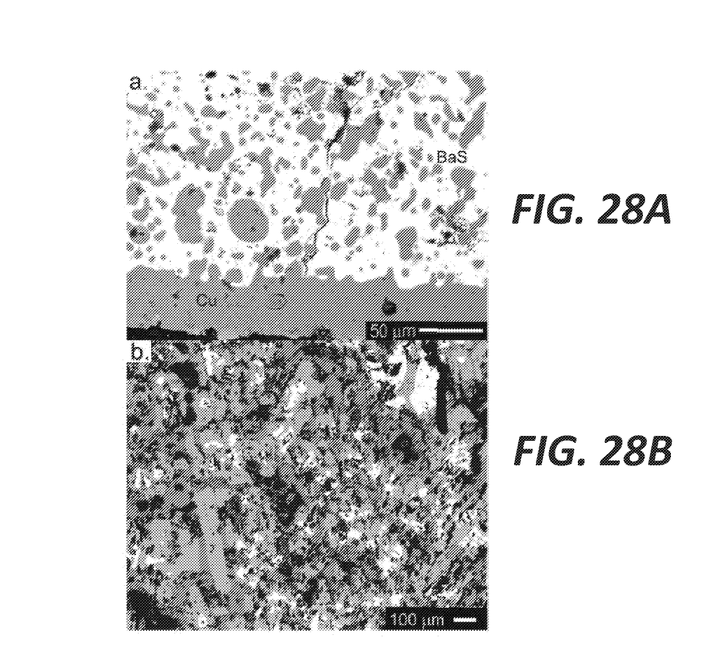

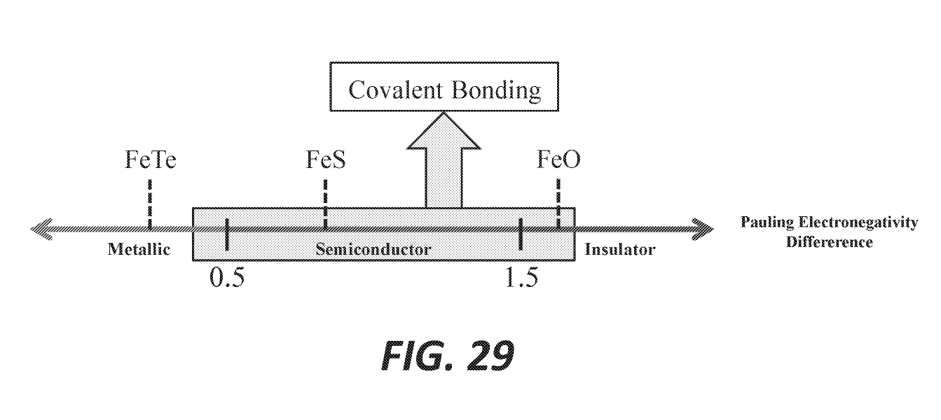

FIG. 27A shows an optical micrograph of the crucible, viewed from the bottom after removal of the crucible. FIG. 27B shows an optical image of a cross-section of the cell illustrating the formation of a void due to gas evolution (10 min. run). FIG. 27C shows an optical image of a droplet of copper recovered in the electrolyte, in cross-section (same run as in FIG. 27A). EDS analysis shows that the metal phase is more than 98 wt % Cu and that the inclusions consist in Cu₂S. FIG. 28A shows a BSE image of the electrolyte near the cathode after electrolysis (30 min run), in cross-section. FIG. 28B shows a BSE image of the bulk electrolyte after electrolysis (same run as in FIG. 28A).

The optical micrographs of the cell, cathode and anode areas as well as a scanning electron microscope (SEM) image of a droplet recovered after electrolysis are presented in FIGS. 27A-27C and FIGS. 28-28B. Lustrous, metal-like, orange-colored droplets are found next to the graphite cathode, as shown in FIG. 27A. Images, shown in FIGS. 27B and 27C, combined with electron dispersive spectroscopy (EDS) analysis of the cross-section show that the droplet is indeed metallic, with an average copper content of the metal phase greater than 98 wt %. The gray-colored inclusions, as shown in FIG. 27C, appear to be Cu₂S particles from EDS analysis. Evidences of a gas phase near the anode in the solidified electrolyte are visible in the optical micrograph in the formed voids near the anode or entrapped in the electrolyte, as shown in FIG. 27B.

SEM observations and EDS analysis of the electrolyte surrounding the cathode, shown in FIG. 28A, indicate a depletion in Cu₂S (respectively an enrichment in BaS), contrary to the bulk electrolyte in which microstructure and average composition are unchanged during electrolysis as shown in FIG. 26 and FIG. 28B, respectively before and after electrolysis.

Faradaic efficiency measurements for increasing electrolysis duration are also reported in FIG. 26. There is a non-negligible uncertainty in those measurements due to the difficulty in recovering of all the metallic droplets which often leave the graphite cathode because of surface tension effects. The results suggest a fair efficiency for copper production in the early stages of electrolysis, with up to 28% faradaic efficiency. At longer electrolysis times a decrease in the faradaic efficiency is observed, indicated by the dashed line and numbers in percent in FIG. 26.

The results of both dynamic (DC and AC voltammetry) and static (constant current) measurements indicate that the electrolysis of the selected BaS—Cu₂S electrolyte enables the formation of metallic copper on the cathode at a cell voltage in reasonable agreement with the thermodynamic predictions. The selective decomposition of copper is in agreement with the decomposition potential series, which predicts that BaS is more stable than Cu₂S. The cathode current density is very high (up to 4 A·cm⁻² assuming the plateau C in FIG. 24 is indeed controlled by mass-transfer), as anticipated from the relatively high concentration of cations in the electrolyte. According to the faradaic efficiency estimated in this work, about one third of that current at 2.5 A·cm⁻² leads to recoverable copper in the proposed cell configuration.

Mass transport during electrolysis plays a key role, in particular leading to the formation of BaS in-situ near the cathode due to depletion in Cu (see FIG. 28A), an inhomogeneity that will locally affect the electrical and other transport properties. The decrease of the measured faradaic efficiency with time, shown in FIG. 26, may be rationalized by the development of a copper-content gradient, though no definite trend in the variation of the depletion layer thickness with time of electrolysis has been observed in these experiments. The simultaneous formation of a gas phase is observed, over a potential range in agreement with predictions for the evolution of elemental sulfur. The wall-like nature of signal A observed in DC cyclic voltammogram in FIG. 24 is an additional result that suggests the decomposition of the electrolyte. Yet, the exact nature of the anodic reaction remains to be confirmed. The direct anodic production of CS₂ is considered unlikely according to prior results of sulfur evolution with a graphite anode. No evidences of crystalline polysulfides have been found by XRD measurements (data not shown), though the presence of amorphous material has been noticed particularly at angles that typically correspond to polymeric sulfur.

The estimated faradaic efficiency proves very dependent on the electrolysis cell configuration and the ability to measure and completely recover the anode and cathode products. In particular, the metal product recovery is often hindered by the dispersion of the metallic droplets due to surface tension effects, as observed in the formation of droplets in FIG. 27A and FIG. 28A, which are particularly important at such small scale. Concerning the nature of the electrochemical reactions, the present work reports the ability to perform AC voltammetry in such an electrolyte, with cathodic signals that qualitatively match those observed in other electrolytes for metal deposition, as shown in FIG. 25 during copper aqueous electrodeposition. Further progress in modeling the AC signal for metal deposition can enable delineation between faradaic and non-faradaic contributions to the electrochemical signals.

The results obtained therefore provides evidence that faradaic reactions can be conducted in a molten BaS—Cu₂S electrolyte, with a minimum of 28% of the supplied charge during electrolysis being transported by ions. This partial ionic character leads to the electrolytic production of copper on the cathode and enables the use of AC-voltammetry techniques.

In some embodiments, the ability to extract liquid copper from molten BaS—Cu₂S melt at 1105° C. has been demonstrated. DC and AC voltammetry revealed that faradaic reactions can be conducted, indicating the partial ionic nature of the selected sulfide melt. The production of copper has been confirmed by galvanostatic electrolysis and high purity copper (greater than 98 wt %) has been obtained. Longer time and dedicated set-up are requested to study the corresponding anodic reaction and its efficiency. The present results indicate that molten sulfides can be considered as a possible supporting electrolyte for metal extraction application. The results also highlight the need for dedicated studies of the electrolyte properties, the electrolysis cell design, and the electrochemical response. In particular, it is foreseen that quantifying the relation between electronic conductivity and faradaic efficiency across the BaSCu₂S binary melt is necessary to optimize the electrolyte composition and cell design.

In some embodiments, the phase diagram of the barium sulfide—copper(I) sulfide system was investigated above 873 K (600° C.) using a custom-build differential thermal analysis (DTA). The melting point of barium sulfide was determined utilizing a floating zone furnace. Four new compounds, Ba₂Cu₁₄S9, Ba₂Cu₂S₃, Ba₅Cu₄S₇, and Ba₉Cu₂S₁₀ were identified through quench experiments analyzed with wavelength dispersive x-ray spectroscopy (WDS) and energy dispersive x-ray analysis (EDS). A miscibility gap was observed between 62 mol % and 92 mol % BaS using both DTA experiments and in-situ melts observation in a floating zone furnace. A monotectic was observed at 94.5 mol % BaS and 1290 K (1017° C.).

Despite their relevance in earth science and materials engineering, high-temperature regions of sulfide phase diagrams—including binaries—are often missing or incomplete, in particular with respect to the stability of their molten phases. This omission is due in part to the experimental difficulty in handling those systems at high temperature, and in part to the challenges faced by current computation modeling practices in predicting solid/liquid equilibria for such systems. Indeed, binary sulfide systems can exhibit a variety of electronic properties across temperature and composition. For example, chalcocite Cu₂S is a p-type semiconductor from room temperature to above its melting point, but can undergo metallization in the molten state at around X K, Y K above its melting point. Solid BaS, considered the most ionic of all alkaline earth sulfides, is presumably an n-type semiconductor with a band gap of 2.1 eV. With increasing concentration, sulfur can also offer a variety of bonding to the metal species leading to metal-like electronic properties (see CuS) or formation of polysulfides (see alkaline sulfides for example).

Due to the relative abundance of Ba and S, its low cost and unique chemical nature, barium sulfide (BaS) is an important sulfide compound which usage is hindered by a lack of thermodynamic understanding of its chemical interactions with other sulfides, including Cu₂S. Despite such uncertainty, its usage in combination in the solid-state with Cu₂S has been put forth for new high temperature superconductors² or recently for photovoltaic materials. Independently, the addition of barium sulfide to copper (I) sulfide (Cu₂S) at 56.8 mol % and 1379 K proved to form a possible electrolyte for liquid copper extraction via electrolysis, where the addition of BaS is thought to decrease the electronic conductivity of Cu₂S.

The development of such new materials or processes requires a better description of the pseudo-binary —Cu₂S, which itself requires new experimental methods. Indeed, The high temperature behavior of pure barium sulfide remains uncertain, with reported values for its melting point ranging from 1473 K to over 2473 K. Consequently, most BaS-containing pseudo binaries and higher order systems have been given little to no attention in for concentrations range rich in barium sulfide. In particular, the BaS—Cu₂S system has been investigated in the region from pure Cu₂S through 60 mol % BaS. The liquidus line for compositions richer than 60 mol % BaS until pure BaS was suggested to be linear, a questionable assumption considering the uncertainty of the BaS melting point.

Described herein is the first thermal stability study over the entire composition range of the BaS—Cu₂S system. Differential thermal analysis (DTA) can be used to identify transitions across the full extent of compositions from 873 K up to 1748 K. With the limited sensitivity of classical DTA systems to accurately detect phase transitions in the BaS-rich region, a novel and easy-to-construct set-up can be designed to maximize the ratio of the thermal arrest signals to background noise. DTA results were supplemented with quench experiments and visual observation of samples in a container-less floating zone furnace, enabling to provide new measurement of the melting point of BaS and visualize in-situ a liquid phase separation for BaS-rich compositions.

The DTA apparatus can include two thermopiles, a sample and a reference, enclosed in an alumina disk (22 mm in diameter, 10 mm in height). Each thermopile includes seven R-type thermocouples (RhPt_{13/}Pt) each held in two-bore alumina tubes arranged in a hexagonal geometry—the fourteen total thermocouples being wired back and forth in series, alternating between the two thermopiles. The fourteen thermocouple geometry can be adopted to maximize the thermal events signal strength in comparison to random background noise, in order to facilitate the detection of first order and second order phase transitions, while retaining a geometry compact enough for the sample and reference to be held in the uniform hot zone of the tube furnace. The circular disk was secured by two alumina rods (220 mm in length, Ø3 mm) to a bottom disk (10 mm in height, Ø22 mm) to stabilize the setup.

Alumina joints were held together using alumina or zirconia paste. Both alumina support rods protruded from the top disk by 10 mm, providing the means to attach an alumina sheath to hold the sample and reference in place. The bottom disk was supported by a four-bore alumina rod (Ø6.13 mm), which ran through a bottom compression fitting that held the DTA setup sealed in an alumina tube (Inner Ø23 mm, Outer Ø25 mm). Additional compression fitting at the top allowed for experiments to be run in an argon atmosphere (99.95% purity, Air Gas). Prior to a run, the system was purged with argon for 15 minutes at a flow rate of 15 cm³·min⁻¹, reduced to 5 cm³·min⁻¹ during a run.

Thermocouple leads measuring the potential difference between the sample and reference compartment, as well as the temperature of the sample (measured from the thermocouple in the center of the sample thermopile) were ran down through the four-bore alumina rod. All exposed thermocouple wires were insulated using single-bore, thin-walled alumina tubes. Voltage and temperature data were collected using a 24 bit data acquisition unit (National Instruments, NI USB-9162, NI-9211) at a data acquisition rate of 3 Hz. To ensure a clear background suitable for thermal signal identification, blank tests without any sample or reference were performed at heating rates of 5 and 10 K min⁻¹, from 293 K to 1473 K. The DTA apparatus was calibrated using the melting points of high purity zinc, aluminum, silver, and copper.

Samples were obtained from mixing barium sulfide [BaS, 99.9% pure metal basis, Sigma Aldrich] with copper (I) sulfide [Cu₂S, 99.5% pure metal basis, Alfa Aesar]. All samples were prepared in an argon glove box to prevent oxidation or hydration. Sample weights from 300 mg to 500 mg were used for DTA.

Samples were held in graphite crucibles sealed in either quartz or molybdenum ampoules. The graphite crucibles (Outer Ø6.1 mm, Inner Ø5.5 mm, bottom thickness of 0.2 mm) were machined from isostatically pressed graphite (e.g., Tokai Carbon). Flat bottom quartz ampoules (Outer Ø9.5 mm, Inner Ø7.0 mm, bottom thickness of 0.5 mm) can be made in-house. The graphite crucible was then placed into the quartz ampoule, the latter being heated under vacuum to a tight fit against the graphite crucible to ensure adequate thermal contact. After loading the graphite crucible with the sample and prior to vacuum sealing, quartz wool was forced down the quartz ampoule to clean the quartz tube of any powder. A quartz rod (Ø6.1 mm) was placed into the quartz ampoule above the quartz wool. The ampoule was then purged with argon and evacuated to a pressure of 200 Pa. The quartz ampoule was then vacuum formed and welded to the quartz rod to provide the seal.

Molybdenum ampoules (Outer Ø9.5 mm, Inner Ø6.13 mm ID, 30 mm depth, bottom thickness of 1 mm) were machined in-house using a lathe equipped with carbide tools. The inner bottom of the ampoule was made flat using an end mill, while the outside bottom was ground flat using 80 grit, 320 grit, 600 grit, and 1200 grit silicon carbide sandpaper. The top 15 mm of the ampoule were internally threaded with a M8×1.25 tap. While in an argon glove box, the graphite crucible was filled with the sample, then pressed into the bottom of the ampoule. A flat cylindrical graphite plug (Ø6.13 mm, 5 mm in height) was pressed onto the top of the graphite crucible in the ampoule. A M8×1.25 threaded molybdenum rod 15 mm in length was tightly screwed into the ampoule to secure the graphite plug flush against the top of the graphite crucible. The atmospheric seal was created by the flat contact between the cap and the crucible top; the threaded rod serving only to hold the cap tightly in place. For DTA experiments, alumina disks (Ø9.5 mm, 0.5 mm thick) were placed between the thermopiles and the molybdenum ampoules to avoid shorting the thermocouples.

For samples in quartz ampoule an empty graphite crucible was used as a reference. For samples in molybdenum ampoules, a molybdenum slug was used as a reference. References were prepared to have equal heat capacities with the sample to ensure a smooth background signal. Heating rates between 1 and 20 K min⁻¹ were investigated, with the optimal rate found to be 10 K min⁻¹ and 300 mg for Cu₂S-rich compositions, and 4 K min⁻¹ and 400 mg for BaS-rich samples. Each sample composition was subjected to three to five heating cycles, from 873 K to 100 K above the anticipated melting point, as determined from the liquidus slope. Temperature ramping was continuous and neither the maximum nor minimum temperatures were held for an extended duration. The first trace served to pre-melt the mixture. Subsequent heating traces showed signals with thermal arrests reproducible to ±1 K. Only the heating traces were used to determine phase transition temperatures, as cooling traces showed significant undercooling.

The melting point of pure barium sulfide was estimated in a floating zone optical furnace. A barium sulfide rod (Ø12.5 mm) was prepared from barium sulfide [BaS, 99.7% metals basis, Alfa Aesar] by sintering at 1748 K for 1 hour in a molybdenum ampoule similar to those used for DTA measurements. The barium sulfide rod was suspended using a nickel wire in the hot zone of the furnace under argon at a pressure of 100,000 Pa, as the power was slowly increased at 1% per minute. The sample rod was observed using a video camera inside the furnace. When the tip of rod was observed to start melting, the power was held constant and the temperature at the tip was measured using a Type C (WRh₅/WRh₂₆) thermocouple. The melting point of a similar rod of composition 80 mol % BaS−20 mol % Cu₂S was also measured.

Quench experiments were performed to identify previously unknown compounds as suggested by the appearance and disappearance of invariant signals. Graphite ampoules of a similar design to the molybdenum ampoules utilized for DTA were used. Samples of 45 mol % BaS, 50 mol % BaS, and 55 mol % BaS were held at temperatures ranging from 1073 K to 1273 K prior to quenching. Samples of 60 mol % BaS were held at 1473 K for 2 hours, then held at 1073 K for 5 hours prior to quenching. Samples of 70 mol % BaS, and 80 mol % BaS were held for two hours at 1473 K and 1723 K respectively. Ice water, liquid nitrogen, or liquid gallium (room temperature) were used as quenching media. After quenching, the samples were placed in epoxy, cross-sectioned, and polished with kerosene using 600, 1200, 2400 and 4000 grit silicon carbide paper. The samples were then analyzed using wavelength dispersive x-ray spectroscopy (WDS) and energy dispersive x-ray analysis (EDS).

The quartz ampoules were significantly easier to make than the molybdenum ampoules, but had several shortcomings. The thin bottom of the quartz ampoule necessitated that the sample be sealed under low pressure to avoid rupture at high temperatures due to gas expansion. At compositions greater than 65 mol % BaS however, the high vapor pressure of the sample coupled with such low internal pressure caused vaporization of the mixture which subsequently attacked the inside surface of the quartz ampoule, reacting with quartz, causing failure of the ampoule. Furthermore, thermal signals of phase transitions became more difficult to detect at higher BaS content, which was further hindered by insufficient heat transfer between the quartz ampoule and the thermocouples.

The molybdenum ampoules solved the problems encountered with barium sulfide rich samples. The enhanced heat transfer from the sample through the molybdenum ampoules to the thermocouples resulted in stronger peaks. The relatively high strength of molybdenum at elevated temperatures allowed ampoules to be sealed under atmospheric pressure at room temperature. At elevated temperatures, argon pressure reached up to 500,000 Pa inside the crucibles, high enough to slow the kinetics of vaporization. The stability in pressure of the ampoule is long enough to reach the melting temperature before vaporization significantly shifts the sample composition. Simultaneously, the pressure is not too high as to have a measurable effect on the thermodynamic measurements of solid-state phase transition or liquidus measurements. Quartz ampoules were used for compositions up to 65 mol % BaS. Molybdenum ampoules were used for compositions ranging from 50 mol % to 95 mol % BaS. In the region from 50 mol % to 65 mol % BaS, both molybdenum and quartz ampoules were utilized and showed good agreement in the obtained phase transition temperatures.

Thermal arrest signals were identified. Data obtained from pure Cu₂S to 55 mol % BaS were in good agreement with prior publication. The region from 60 mol % BaS revealed several previously unknown features. In compositions ranging from pure Cu₂S to 70 mol % BaS, cross-sections of the DTA ampoule showed the existence of one solidified, shiny, liquid (L1). In compositions ranging from 92 mol % BaS to pure BaS, the solidified liquid appeared less shiny, ionic-like solid (L2). In compositions ranging from 75 mol % to 90 mol % BaS, both solidified liquids were present), indicating that the presence of a liquid miscibility gap.

The melting point of BaS was found to be 2508 K, in good agreement with previous high temperature readings, further corroborating the notion that the melting point of barium sulfide is highly susceptible to impurities, with lower reported values inherited from the presence of such impurities. Through the heating trace, minimal vaporization was observed before melting. Upon melting, the color of the barium sulfide changed from off-white to dark grey and the rate of vaporization observed with the camera increased.

Floating zone melting and in-situ video recordings at 80 mol % BaS showed the presence of two immiscible liquids—one that appeared reflective; and one that appeared dark and opaque. Upon melting, the sample was observed to phase separate, with the opaque liquid being at the bottom of the droplet. High rates of vaporization from the liquids prohibited heating of the sample above the critical point of the miscibility gap. Upon cooling, the opaque liquid (L2) was found to correspond to the ionic solid, while the reflective liquid (L1) was found to correspond to the shiny, metal-like solid observed in FIG. 4 with DTA ampoules.

The appearance and disappearance of invariant signals predicted three new compounds—one at approximately 65 mol % BaS, one at approximately 72 mol % BaS, and a syntectic compound at approximately 90 mol % BaS. Quench experiments were utilized to verify the composition of these compounds. EDS and WDS analysis confirmed these compounds to be Ba₂Cu₂S₃, Ba₅Cu₄S₇, and Ba₉Cu₂S₁₀ respectively. The known compounds BaCu₄S₃ and BaCu₂S₂ were observed, as well as another new compound, Ba₂Cu₁₄S₉. Ba₂Cu₁₄S₉did not appear on any DTA signals, indicating that the compound decomposes below the minimum studied temperature of 873 K. The quench experiments performed on the 80 mol % BaS from 1723 K showed the existence of only one liquid, indicating that the critical point of the miscibility gap occurs in the temperature range studied by DTA.

Based on the data collected through DTA, quench experiments, and floating zone tests, an updated phase diagram can be proposed for the pseudo binary Cu₂S—BaS. The Cu₂S-rich side phase boundaries up to BaCu₂S₂ (50 mol % BaS) are confirmed. A eutectic Cu₂S—BaCu₄S₃ at 27 mol % BaS is found at a temperature of 908 K with BaCu₄S₃ and BaCu₂S₂ disappearing peritectically at 933 and 1028K. A polymorphic transformation of BaCu₂S₂ may be responsible for the unattributed invariant at 873K, though dedicated study would be necessary to validate this finding. More importantly for novel usage of BaS, the liquidus are found to be drastically lower than predicted by Andreev in the region ranging from 55 mol % to 95 mol % BaS, and 3 new compounds (Ba₂Cu₂S₃, Ba₅Cu₄S₇, and Ba₉Cu₂S₁₀) and a miscibility gaps are found. The first compound (Ba₂Cu₂S₃, or 2BaS.Cu₂S, 65 mol % BaS), forms as a peritectic from BaCu₂S₂ at 1028K and disappears peritectly at 1089K, suggesting that its synthesis from the melt will be difficult. It is indeed bounded by Ba₅Cu₄S₇ (5BaS.2Cu₂S, 72 mol % BaS) above 1089K, itself stable until 1278K. Ba₅Cu₄S₇ is the last high temperature compound stable until the miscibility gap, disappearing peritectically to form the Cu₂S-rich liquid and Ba₉Cu₂S₁₀. Ba₅Cu₄S₇ is in principle a compound easily formed from a melt, thanks to its broad range of immiscibility in both composition (55 to 72% BaS) and temperature (around 200K).

Ba₉Cu₂S₁₀ (9BaS.1Cu₂S, 90 mol % BaS) is the most stable compound found in this thermal study, responsible for the liquid-liquid immiscibility demonstrated by both quench DTA (FIG. 4) and in-situ floating-zone observations. The miscibility gap is observed from 72 mol % to 92 mol % BaS at a temperature of 1351 K. Its critical point was found at 82 mol % BaS at a temperature of 1469 K. Thanks to its mixing with a Cu₂S-rich liquid up to 1351K and a monotectic with 94.5 mol % BaS at a temperature of 1288 K, Ba₉Cu₂S₁₀ thermal stability enables liquids to be formed at very high BaS-content at more than a 1000K below BaS melting point.

Solid state thermoelectric devices have been known and utilized for decades for applications including cooling, heating, energy conversion, waste heat recovery, sensing, and thermal-expansion management. Their benefits include the small form factor, high power density, flexibility to heat source, and free of moving parts. However, thermoelectric devices have not achieved widespread use for primary energy generation or waste heat recovery due to two primary factors: inefficient devices and high dollar per Watt generation costs. Consequently, to date, thermoelectric devices have been limited to applications, where space savings or lack of moving parts are primary driving factors, such as powering satellites and seat-coolers for automobiles.

The technologies described herein employ alternative material systems, devices, and methods of manufacturing and operation to solve the issues mentioned above. These technologies use molten thermoelectric systems. Molten semiconductivity has been known for years, but is not yet well described with a consistent predictive theory. Further, substantial challenges to the experimentalist and engineer are presented by working with the molten state. Consequently, the exploration of the utility of molten thermoelectric devices has been under-investigated to date.

The research efforts seek to rectify this gap in knowledge and application, and have demonstrated the utility of molten thermoelectric devices. The categories of thermoelectric technologies include several major categories: 1) methods of selection of molten thermoelectric materials; 2) methods of design of devices utilizing molten thermoelectric materials; 3) designs of devices utilizing molten thermoelectric materials; 4) designs of systems associated with molten thermoelectric materials; 5) uses of molten thermoelectric systems and devices; and 6) methods of manufacture for devices and systems incorporating molten thermoelectric materials.

A connection between certain features of phase diagrams, described by thermodynamic models, and the electronic and thermoelectric properties of molten semiconductors can be found and exploited. A predictive framework can be employed to predict the properties of molten materials relevant for the selection and optimization of thermoelectric materials for the above-mentioned applications. This framework can serve as the basis for a series of methods, wherein a material is selected based on certain properties previously thought to be unrelated, or only tangentially related, to its operation as a thermoelectric.

The geometry, materials selection, and design features of molten thermoelectric devices are intimately coupled to the desired working environment, material system used, and specifications. It is helpful to have a method to specify aspects of design geometry and material selection based on a specified mode of operation, environment, and material system parameters.

Several designs of devices for operation with molten thermoelectric systems can optimize performance for given applications or environmental conditions. Several key applications of molten thermoelectrics mentioned above place specific limitations on the design and integration of devices. As an example, integration of molten thermoelectric waste heat harvesters into a metal smelter's operations involves design of a refractory system that incorporates the thermoelectric device, heat exchanger, and refractory for containment of the molten metal system. Several system-level designs for such integrations have been proposed and they are the first attempt to incorporate by design thermoelectrics into furnaces, and certainly molten thermoelectrics into furnaces.

Because of the lack of investigation of molten thermoelectric systems, exploration of the utility of such systems has been lacking. Several key uses are identified for the material system. An example would be the use of a molten thermoelectric device for waste heat harvesting in a glass furnace.

There are several novel aspects to the designs of systems and devices incorporated into this disclosure. Several manufacturing methods and techniques are identified to thermoelectrics incorporating molten materials that have the potential to drastically lower the system cost, not just the material cost.

The investigation of molten compounds for metallurgical applications to select and investigate material systems is of particular interest for application in molten thermoelectric devices. Molten semiconductor systems may have several advantages over their solid-state counterparts, including high temperature operation, tailorable temperature range of operation, tunable performance as a function of dynamically controlled factors, reduced sensitivity to defects and impurities, low cost, low cost manufacturing technologies, flexible geometry, dynamic geometry, self-healing, ability to flow, controlled viscosity, allowance of operation of multiphase systems, ability to incorporate phase transition, and distinct ability to tune thermal, electrical, and mechanical properties.

The high temperature operation possibility, low-cost material systems, and low-cost manufacturing technologies may substantially address the primary barriers to adoption of thermoelectrics described above: efficiency and dollar/Watt respectively.

Substantial opportunity exists for the conversion of industrial waste heat to useable power. A Department of Energy (DOE) study released in 2006 delineates the magnitude and details of the opportunity. Recoverable exergy from industrial waste heat comprises over 2% of the electricity use in the United States. Cost is a primary driving factor for thermoelectric waste heat harvesting applications. Researchers have confirmed that the primary barrier to waste heat harvesting is the lack of an economical, scalable, space efficient thermal conversion device capable of operating at temperatures between 500° and 1600° Celsius. Both the DOE and independent researchers have identified next generation “solid state” devices, and specifically high temperature, low-cost thermoelectrics, as the best hope of achieving a waste-heat conversion solution. The primary electricity generation market alone represents an over $1 trillion market.

Application of waste heat recovery to the metallurgical, glass, incineration, cement, and ceramics sectors could have dramatic impact to the cost of capital and cost of operations to these multi-billion dollar industries. Improved efficiency of operations can result in reduced capital expenditure and lower cost operations.

Waste heat recovery for transportation has been discussed at length, but not in the context of molten semiconductors. Substantial improvements can be made in the efficiency of operation of vehicles, airplanes, ships, and other means of transportation that generate heat.

There are many other markets, such as boilers and combustion, which may be addressed by the availability of molten semiconductor devices that are reasonable efficiency and low-cost. Technologies described herein can function as a platform.

A thermodynamic method for predicting the thermoelectric behavior of molten sulfide systems is described herein. High temperature molten systems have demonstrated great utility in applications such as energy storage, materials processing, and metals extraction. Some examples include: liquid metal batteries, molten salts for concentrated solar, electrolysis for steel production, and glass processing and synthesis.

Certain systems have the particularly intriguing characteristic that they express semiconducting properties and, more specifically, thermoelectric properties in the molten state. Systems exhibiting these characteristics include selenides, tellurides, sulfides, antimonides, and some oxides. Of these systems, the tellurides and the sulfides express the most desirable electronic properties (i.e. Seebeck coefficient and electrical conductivity) for use in thermoelectric applications.

Sulfides, in particular, express a wide range of electronic properties in the molten state, from metallic to insulator, and over a wide range of temperatures (e.g., about 400° C. to about 2200° C.). Their use for thermoelectric applications in the solid state has been of interest for decades. Of particular significance is the relative abundance of sulfides in the earth's crust relative to tellurides (the industry standard thermoelectric material system) which imparts a cost and availability advantage to sulfide thermoelectrics .

Substantial opportunity exists for the conversion of industrial waste heat to useable power. A Department of Energy (DOE) study released in 2006 delineates the magnitude and details of the opportunity. Recoverable exergy from industrial waste heat comprises over 2% of the electricity use in the United States. Cost is a primary driving factor for thermoelectric waste heat harvesting applications. Researchers have confirmed that the primary barrier to waste heat harvesting is the lack of an economical, scalable, space efficient thermal conversion device capable of operating at temperatures between 500° C. and 1600° C. Celsius. Both the DOE and independent researchers have identified next generation “solid state” devices, and specifically high temperature, low-cost thermoelectrics, as the best hope of achieving a waste-heat conversion solution.

Many researchers in the field of thermoelectrics have focused on performance metrics such as ZT, or the figure of merit, which describes the efficiency of conversion achievable by a material system. However, efficiency may not be the appropriate metric to evaluate thermoelectric conversion for primary power generation. Instead, cost per watt can be the useful metric for evaluating thermoelectric devices. Thus, achieving cost-parity with market prices for electricity can be considered the goal of a “solid state” waste heat conversion device. From this perspective, the notion of a liquid semiconductor based thermoelectric device comprised of molten sulfides becomes an attractive idea for investigation.

Liquid semiconductors, and specifically liquid sulfides, can be used for liquid thermoelectric conversion. Antimonides and tellurides can be used to build a molten thermoelectric conversion device, and the addition of a third component to the systems can improve performance to economical levels. In addition, an operable high temperature sulfide-based liquid state p-n junction is also practical.

Progress on the investigation and practical use of liquid semiconductors, and more specifically molten sulfide thermoelectrics, may be limited by the inadequacy of the theory and predictive capacity for liquid semiconducting behavior. Substantial progress in the structural basis and qualitative behavior of liquid semiconductors has been made. However, a scientific gap still exists. For example, current methods do not predict whether a system can exhibit semiconducting behavior in the liquid state, nor the extent of this behavior, with sufficient quantitative accuracy for practical use. The practical questions to design thermoelectric liquid state devices include: is the material system a semiconductor in the liquid state, and over what range of thermodynamic conditions does it remain a semiconductor? A unique opportunity exists for answering these questions for molten sulfides that leverages the available thermodynamic data and models for these systems.

The framework to predict thermoelectric properties of molten sulfide semiconductor systems using thermodynamic methods is described herein. Such a framework can enable the incorporation of empirical thermoelectric data into thermodynamic databases and the prediction of key material properties without the need for intensive atomistic simulation for the development of high temperature liquid thermoelectric generators.

Liquid semiconductors exhibit many similar properties to their solid counterparts including the effect of temperature on electronic conductivity, thermoelectric behavior, and optical band gaps. However, not all systems that behave as semiconductors in the solid state retain their semiconducting properties once molten, and the initial efforts to describe these liquid systems sought to understand the relation of the properties of the liquid state to those of the solid semiconductor.

Early studies of these systems resulted in a phenomenological classification of liquid semiconductors into three categories: those that experience a semiconductor to metal (SC-M) transition upon melting, those that experience a semiconductor to semiconductor (SC-SC) transition upon melting, and those that experience a semiconductor to semimetal transition upon melting (SC-SM). The primary differentiating features of these systems are their electronic properties as a function of temperature, and specifically the behavior of the electronic conductivity and Seebeck coefficient, as shown in Table 2.

While the above classification may seem arbitrary or tautological, empirical evidence supports this effort and demonstrates that most systems do indeed fall squarely into one of the categories.

Previous efforts in the field sought a theoretical description that can support the empirical classification. For example, one theory describes the quintessential connection of short range order (SRO) to the electronic properties of disordered materials. Theories of solid state electronic behavior typically had relied upon the existence of long range order (i.e. crystallinity) to accommodate properties such as band gaps. However, the prescriptive and paradigm-shifting realization in this theory laid the groundwork for a new field of physics: the study of disordered systems.

Another theory can be built upon the one above to create a new framework and theory for the electronic properties of disordered systems. Further empirical studies of elemental and binary liquid semiconductor systems laid the groundwork for a chemical description of the foundation of SRO in semiconducting melts. Studies describe qualitatively how the nature of chemical bonding in a system relates to its SRO and hence electronic properties. Specifically, binary systems that exhibit semiconducting behavior tend to be composed of elements of with electronegativity differences associated primarily with covalent bonding. While difference in electronegativity does not contain sufficient physics to fully describe whether a system will behave as a metal, semiconductor, or insulator, a general trend exists.

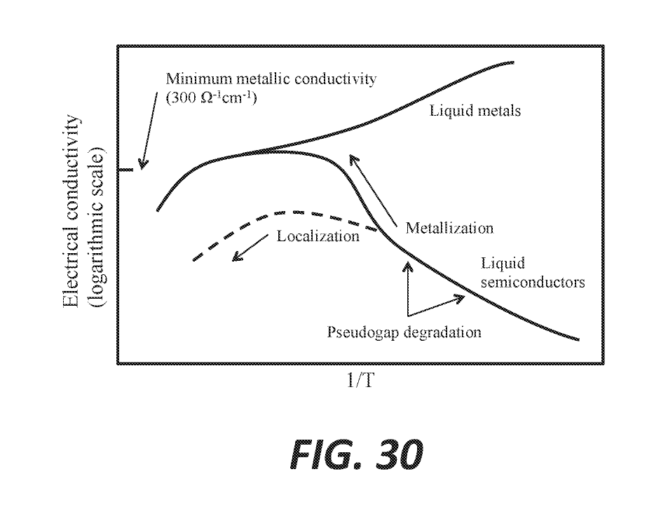

FIG. 29 shows semiconductor behavior as a function of Pauling electronegativity difference and qualitatively outlines the difference in Pauling electronegativity associated with semiconductivity in the liquid state. It should be made clear that this categorization does not accurately capture all systems. Systems with too extreme a difference in electronegativities between constituents tend to behave ionically and act as true insulators, whereas systems with too minimal a difference in electronegativity have a strongly metallic character and fail to exhibit desirable semiconducting properties.

Rigorous quantitative support for the role of short range order in liquid semiconducting behavior came in the form of neutron scattering data. A series of three structure factors are used to describe the SRO of the system. These structure factors can be transformed into the radial pair distribution functions and are measurable via high energy diffraction experiments. Armed with a useful formalism, experimentalists tackled the problem of investigating the evolution of short range order upon melting and into the liquid state via high energy diffraction. Numerous studies show the degradation of long range order upon melting in terms of structure factors and/or radial distribution functions, and confirm that systems that exhibit metallization (SC-M) correspondingly exhibit a degradation of short range order. However, systems that experience a SC-SC transition in fact retain many of the structural features of the solid state. Experts in the field unanimously agree upon the prescriptive connection of SRO to the semiconducting properties of the liquid state.

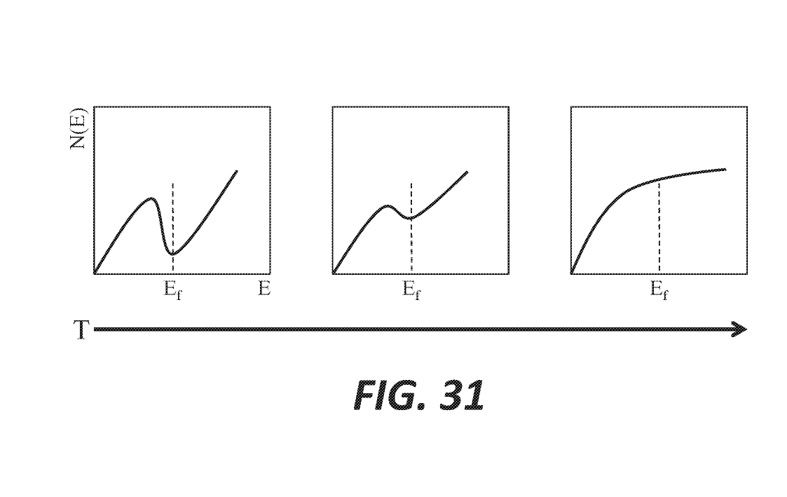

With strong foundations for the nature of the transition from solid to liquid state, efforts to develop an understanding of the electronic behavior of liquid semiconductor systems above the liquidus continued. Systems that experience a SC-SC transition across the liquidus usually do not retain semiconducting properties indefinitely. At temperatures above the melting point, liquid semiconductor systems metallize and experience a loss of semiconductivity. The electronic conductivity of semiconducting systems typically increases monotonically as a function of temperature until such a point as it reaches what is referred to in the field as the “minimum metallic conductivity,” which is the typical electronic conductivity in a metallic system when the mean free path of an electron is of the same order as the interatomic spacing. Further, at sufficiently high temperatures, all classifications (SC-SC, SC-SM, and SC-M) experience a metal-to-insulator transition. FIG. 30 shows evolution of conductivity of semiconducting and metallizing melts and illustrates the regions of behavior for SC-SC and SC-M systems.

Two primary frameworks can be used to account for the observed behavior of these systems. The first framework relies upon a description of the band structure of disordered systems. The second framework relies upon a heterogeneous description of the liquid state and leverages Percolation Theory to account for electronic properties. Both frameworks have led to moderate successes in describing the evolution of semiconducting properties of the liquid state and both will be described accordingly.

The first framework (also referred to as Mott/Anderson model) of liquid semiconductivity relies on a qualitative description of the evolution of the density of states of the system as a function of temperature. Replacing the complete band gap in crystalline solid state devices, Mott/Anderson model suggests the formation of a “pseudogap”, or a dip in the electronic density of states for disordered systems expressing semiconducting behavior. The lack of long range order makes unlikely the possibility of a true band gap. However, the notion of localization of electrons within the pseudogap provides an alternative mechanism to create a critical phenomenological feature of semiconducting behavior: the thermal excitation of electrons across a mobility gap. The localization is hypothesized to be Anderson Localization, caused by the mean free path of the electrons being of the same order as the distance between atoms. Thus, while electronic state do exist in the pseudogap, the mobility of electrons in the gap is substantially destroyed due to localization effects. Thus, a “mobility edge” takes the place of a band edge for disordered systems.

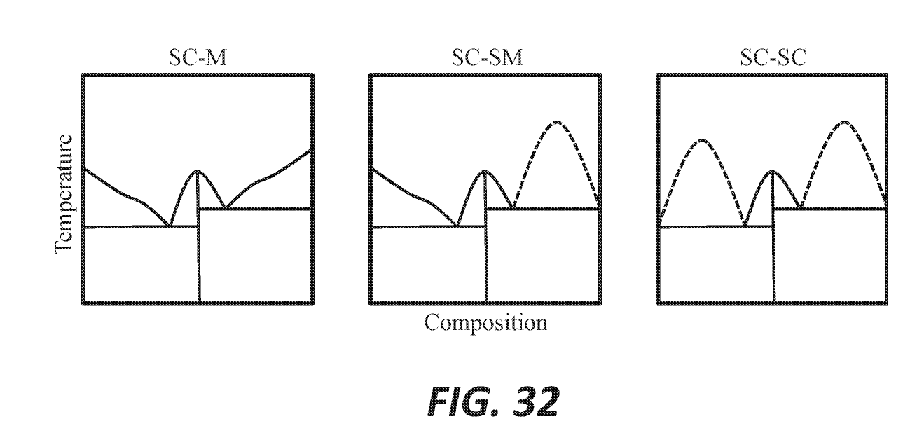

As temperature is raised, short range order is presumed to degrade resulting in a “filling-in” of the pseudogap such that the semiconducting properties gradually decline, as shown in FIG. 31. At the point at which the mobility edges overlap, thermal activation of electrons to the conduction band ceases to be the dominant mechanism of transport and metallization occurs. The electrical conductivity and Seebeck coefficient can be modeled by an application of the Kubo-Greenwood equations.

While providing qualitative agreement with the data, the Mott formalism has met with substantial challenges that severely limit its utility in providing quantitative descriptions of the liquid state. Most critically, the framework provides no means to predict whether a system can behave as a semiconductor without appeal to empirical evidence. Further, without a continuous definition of the energy-dependent conductivity or density of states, the description of the evolution of a system to metallization, while qualitatively accurate, does not accurately quantify the transition point. This has been repeatedly demonstrated by efforts to apply the formalism to specific material systems. Liquid semiconducting systems express complex behavior that varies as a function of temperature, and thus simplifying approximations to the full rigor of applying the Kubo-Greenwood equations regularly fail to provide even qualitative agreement with experiment.

An alternative to the Mott/Anderson description of liquid semiconductivity (also referred to as Hodgkinson—Cluster theory) relies upon a presupposition of microscopic inhomogeneity of liquid state semiconductor systems. It is hypothesized that the strong tendency for short range order in liquid semiconductor systems is manifested by the retention of molecular entities reflecting the stoichiometry of a solid state compound which cluster together in the molten state. Thus, microscopic clusters of semiconducting species are present in a dominantly metallic matrix. When the volume fraction of clusters is sufficiently high (greater than approximately 70%), no continuous path through the metallic matrix is present in the system and conductivity is dominated by the semiconducting element of the heterogeneous system, as described by Percolation Theory. As the temperature is raised, the tendency of molecular entities to cluster degrades.

This theory can qualitatively describe the semiconductor to metal transition, the change in character of semiconducting behavior from n to p type at the stoichiometry of the solid state compound, and the thermoelectric properties of the system as a function of temperature. Further, as described below, thermodynamic models of liquid semiconductor systems may support a description of the liquid state wherein molecular entities reflecting the stoichiometry of the solid state compound are present in large concentrations in the liquid state.

However, despite its qualitative success, as yet the theory has no means to predict whether a system will behave a semiconductor in the liquid state without direct empirical comparison. Further, the description of the semiconductor to metal transition is not quantitative, and does not provide a means to predict the temperature of the transition. This framework has been met with much skepticism, and high energy diffractive experiments attempting to resolve the presence of microscopic inhomogeneities have proven inconclusive. It is most likely that this description is valid for certain systems, but not for the general category of liquid semiconductors.

The advent and rise to prominence of atomistic simulation provided a new tool with which to explore the structure and properties of the liquid state. The complex nature of semiconducting liquid systems confers substantial challenges to the atomistic modeler. Specifically, the absence of long range order, strong influence of short range order, and high degree of covalent character of interatomic bonding make use of traditional, classical potentials of questionable use. Thus, the majority of explorations of the use of computer simulation to describe liquid semiconductors have leveraged first-principles, or ab initio, potentials, typically within a Density Functional Theory (DFT) framework, coupled with Molecular Dynamics (MD) (Car-Parrinello approach) or Monte Carlo (MC) simulations.

Research efforts have validated much of the phenomenological description of the previous decades and have provided direct access to probing the structural evolution associated with liquid semiconductor systems and their transitions. Further, the ab initio approach gives a quantum-mechanical description of the electrons that allows for the direct probing of the density of states and band gap of the system. Molecular Dynamics simultaneously provides transport property information, such as diffusivity, which can be related to physical properties of the system of practical interest.

However, while atomistic simulation has proved a capstone achievement in confirming much of the theory and phenomenology of liquid semiconductors, there are substantial practical challenges with this approach. The simulations are computationally intensive due to the need to perform quantum mechanical calculations at multiple steps in the MD simulation. Further, substantial tuning of pseudopotentials has been required to achieve results by the above practitioners. This can be understood by recognizing that for many systems of interest, electrons beyond the valence electrons participate in energetics of bonding and consequently potentials that treat only valence electrons fail to accurately describe many systems. Consequently, the presence of additional species, and the simulation across multiple concentrations, requires new simulations, each requiring substantial input and tuning from the modeler. Thus, the ability to leverage atomistic simulation as a tool for screening complex systems for semiconducting potential is reduced by the time and effort intensiveness of the process.

Still further, atomistic simulation has proven quantitatively inadequate in the prediction of temperature of critical features such as the liquidus and semiconductor to metal transition. Simulations are considered successful when errors are in the 100's of degrees Celsius range. Thus, while incredibly useful in probing the structural foundation for electronic properties in the liquid state, atomistic modeling has yet to demonstrate itself as a practical tool for the engineer wishing to incorporate liquid semiconductor systems into systems and devices.

It is of interest to outline key connections and differences between the study of liquid systems, and more specifically liquid thermoelectric systems, and other fields of research. The study of solid state semiconducting disordered systems, i.e. amorphous semiconductors, has achieved significant results of practical interest in the decades since Mott. Kolomiets, in a well-regarded 1964 review article, discusses the role of short range order and covalent bonding character in defining the semiconducting properties of solid state amorphous systems. Indeed, the description of solid state disordered systems and liquid state disordered systems are highly complementary and in fact do not exhibit substantial differences in the source and behavior of electronic properties. This is reflected in the role of short range order in defining the properties of disordered systems.

However, several practical differences do present themselves when considering the distinction between liquid state and solid state disordered systems. The temperature ranges of liquid systems exceed those of amorphous systems. Liquid systems tend to exhibit electronic characteristics closer to the metallic end of the semiconducting spectrum than the insulating end (primarily as a function of the thermal excitation of electrons). Further, and most meaningfully, liquid semiconducting systems are true equilibrium systems, whereas their solid state amorphous counterparts are metastable systems.

This distinction has several consequences. First, it is a significant challenge to the experimentalist wishing to study amorphous systems to achieve repeatable samples due to the influence of thermal history on the structure of system. Second, the presence of thermodynamic equilibrium for liquid state systems allows the use of the full range of thermodynamic modeling to describe the system. A study of the thermoelectric, and, more generally, semiconducting properties of liquid state systems can shed substantial light on the physics of amorphous systems.

While physicists and material scientists pursued a description of the electronic properties of liquid semiconductors, metallurgists, in parallel, began thermophysically and thermochemically characterizing complex slag systems for the metals extraction industry and geological studies. Many natural minerals, such as chalcopyrite, galena, cinnabar, molybdenite, and sphalerite, have substantial sulfur composition and in order to improve the efficiency of extraction processes, and to further develop an understanding of rock formation processes, many researchers sought a more complete description of the high temperature, molten behavior of sulfur-rich systems. More specifically, the practical engineer and geologist sought phase diagrams for these systems.

The thermodynamic field of predicting phase diagrams has achieved great practical success in the past 50 years. Thermodynamic descriptions of material systems amenable to phase diagram interpretation typically seek a description and functional form of the Gibbs free energy of species. Sulfur-rich systems, as detailed above, tend to exhibit strong short range order and complex interactions. Consequently, simplistic thermodynamic models for the free energy, such as the regular solution model, are rendered ineffective for accurate prediction of key elements of the phase diagram. More complex models of the free energy, reflecting a more physically realistic description of the entropy of covalent liquids, have been a focus of metallurgists and thermodynamicists for decades. Many models of Gibbs free energy relevant for complex liquid systems rich in sulfur have been proposed over the years, and each framework has relative advantages for the thermodynamic modeler. Table 3 outlines some of the key methods to model the Gibbs free energy used by practicing thermodynamicists.

On their own, the utility of the above-described Gibbs free energy models can be limited. But when coupled with computer-automated energy minimization software, their potency is multiplied and each can be used to generate self-consistent phase diagrams and perform thermodynamic calculations. Several primary thermodynamic software packages for the generation of phase diagrams (the CALPHAD approach) have been developed, including FactSage and Thermo-Calc. Of critical import to these software packages, and the free energy models, is the availability of empirical data with which to optimize the thermodynamic description, and it is indeed in this aspect that the tools are differentiated.

The availability and utility of thermodynamic data for sulfide systems has been dramatically improved by thorough investigation of metallurgical and geological professionals and academics. For example, Kullerud produced a review article titled “Sulfide Phase Relations” summarizing the available thermodynamic data for sulfide systems. The compendium included a plethora of binary, ternary, and quaternary systems. Generation of phase information for sulfide species has continued, and many investigators have continued to populate thermodynamic databases and produce phase diagrams relevant for a practical study of sulfide behavior. Critically, the generated databases have been used successfully to predict ternary and higher order multicomponent system properties from binary data with modern software packages, demonstrating the power that a thermodynamic modeling approach can have for the practicing engineer.

Thus, whereas atomistic simulation has struggled to achieve quantitatively accurate predictions of melting points and semiconductor to metal transitions, modern calculation of phase diagrams has provided a consistent framework with which to accurately predict critical elements of phase diagrams. However, thermodynamic models do not as yet explicitly engage with the electronic nature of the systems, and the notion of a free energy based calculation of the density of states is viewed as farfetched. Consequently, it has been challenging to date to bridge the gap between a thermodynamic description and the electronic properties of liquid semiconductor systems, especially as constrained by the conceptual framework of Mott et al. which requires a knowledge of the evolution of the electronic density of states of a system to accurately predict semiconducting behavior.

However, the free energy of a species is fundamentally dependent upon structure. As mentioned above, the more closely approximating of short range order the free energy model, the better predictive ability. Thus, it should not be surprising the elements of phase diagrams connected to the SRO of the system may correlate to, if not explicitly be reflective of, elements of electronic properties.

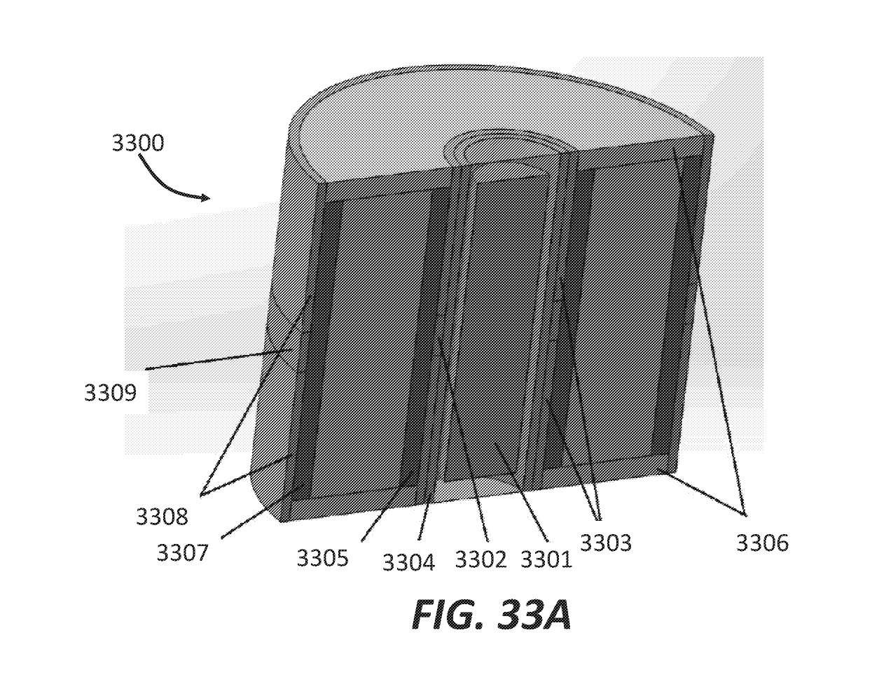

The notion of the connectivity of features of phase diagrams to the electronic properties of liquid semiconductors is not new. Cutler, in his comprehensive 1977 monograph, reflects on the correlation of liquid phase immiscibility with systems displaying semiconducting properties in the liquid state. This notion was recently furthered by a rigorous correlation study of hundreds of binary systems exhibiting SC-SC, SC-SM, and SC-M transitions by Belotskii et al. in a series of articles. Belotskii goes further to describe particular phase diagram features that correlate to the different transitions that may occur upon melting. Binary systems that metallize (SC-M) do not exhibit liquid-liquid miscibility gaps. Binary systems that remain true semiconductors (SC-SC) have two liquid-liquid miscibility gaps. Finally, binary systems that exhibit semimetal or semiconducting behavior over a subset of composition display a single liquid-liquid miscibility gap. FIG. 32 shows a graphical summary of the behavior.

Belotskii and Cutler agree upon the source of liquid phase immiscibility: the liquid state accommodates a solution of primarily covalent character as well as solutions of primarily metallic behavior. The inhomogeneity of these solutions leads to immiscibility. Thus, the presence of the characteristic phase diagram features reflects the chemical bonding of the melt, which is similarly coupled to the SRO, as described above.

Thus, it seems reasonable to submit that for sulfide semiconductor systems, prediction of the presence of miscibility gaps in the liquid state may be used as a proxy for prediction of liquid semiconducting behavior. Still further, recent studies on the behavior of liquid semiconductors beyond the liquidus have revealed additional connection of features of phase diagrams to the evolution of semiconducting properties of liquid systems. Sokolovskii et al., followed by Didoukh et al., performed a series of experiments on selenide and telluride systems whereby they measured the electrical conductivity and Seebeck coefficient as a function of temperature in the vicinity of a critical point of a liquid phase miscibility gap. The results are clear: a semiconductor to metal transition occurs at the precise point of the critical point in the phase diagram.

Explanations for this behavior appeal to the influence of electrons on miscibility, however a recognition of the nature of the second order transition occurring at the critical point reveals a deeper connection between the SC-M transition and the onset of complete miscibility. Fundamentally, the critical point reflects a continuous order-disorder transformation, whereby the order parameter reflects density or concentration variation in the system. The higher temperature phase exhibits disorder. The connection between the degradation of semiconducting properties and the reduction of order was demonstrated above: the semiconducting properties of liquids depend on SRO. The continuous semiconductor to metal transition at the critical point of a miscibility gap in the phase diagram of a liquid semiconductor thus reflects a “filling in” of the pseudogap, as shown in FIG. 31, which, as described above, is connected with a reduction in covalent bond character. Per Belotskii and Cutler, immiscibility is no longer possible without a dominantly covalent phase. The connection between the phase diagram and the semiconducting properties of liquid systems has thus been thoroughly demonstrated by correlation studies.

The relationship of short range order to the semiconducting properties of liquid semiconductors is clear. Near the liquidus, the behavior of the liquid state is well described by the extension of solid state theory. However, at temperatures beyond the liquidus, the less relevant models of semiconductor behavior based on crystallinity become. The current theory of liquid semiconductivity requires knowledge of the density of states of the system to predict the thermoelectric properties as a function of temperature. The existing model has consistently failed to provide prediction of the semiconducting properties of systems without substantial tuning to specific empirical results.

Atomistic simulation has proven highly effective at describing the evolution of semiconducting properties through the semiconductor to metal transition, however the lack of quantitative accuracy and time and effort intensiveness of the modeling process renders it less useful as a screening technique for multicomponent systems. Without atomistic modeling or direct empirical measurement, our ability to predict whether a system will behave as a semiconductor in the liquid state is limited to Mendeleev rules that do not well extend to ternary and higher order systems. Thus, the field currently lacks a framework by which to efficiently predict whether a system can behave as a semiconductor in the liquid state and when said behavior can degrade as a function of temperature. Further, existing methods break down, or become overly burdensome, when considering multicomponent systems.

The connection of phase diagram features to semiconducting phenomena has been rigorously realized fairly recently. Further, thermodynamic data for most semiconducting material systems (i.e. selenides, tellurides, and antimonides) is relatively scarce. On the contrary, due to the industrial utility of sulfide systems and sulfur-bearing slags, a relative abundance of thermodynamic information is available on these systems. Consequently, a unique opportunity to explore the connection between thermodynamics and semiconducting behavior of liquid systems exists for of molten sulfides.

The practical questions for the engineer considering the use of liquid semiconductor systems, and more specifically liquid thermoelectrics, include: is the system a semiconductor in the liquid state, and over what range of temperature and composition is it a semiconductor? The current state of the art does not provide answers to these questions. A thermodynamic framework can be used to answer these questions, leveraging the existing theory of electronic behavior of liquid semiconductors and the modern, robust toolkit of thermodynamic modeling.

The first task will be to select the material systems. The down-selection can occur via a number of criteria including: availability of existing thermoelectric and thermodynamic data, representativeness of the semiconducting properties of sulfide systems of interest, temperature range of operation (lower is easier to manage experimentally), vapor pressure of volatile species (lower is easier to manage experimentally), and safety (absence of toxicity, combustibility, etc.).

An experimental apparatus can be built to perform high temperature thermoelectric and electrical conductivity measurements in a controlled environment. The device leverages elements, such as graphite electrodes, alumina crucibles, and an argon environment, induction for the heating element, and the vertical travel afforded by the design. These features are designed to enable a more rapid screening across temperature ranges for a given composition. The basic function of the device has been tested with molten aluminum.

The apparatus can be validated for use with systems expressing the semiconducting properties and phase diagram features of interest for the proposal. This can occur through the testing of a known material system that expresses liquid semiconducting behavior over a range of composition and temperature. Validation can be achieved should the device substantially reproduce the results of Seebeck coefficient and electronic conductivity measurements reported in the literature for the known material system.

The next step is to perform experiments on a binary material system with a known phase diagram, but an incompletely mapped-out Seebeck coefficient and electrical conductivity over the composition and temperature range of interest to sample the miscibility gaps and near the stoichiometric compound. The point of this step is to validate two hypothesis inherent in this proposal: 1) the presence of miscibility gaps is associated with liquid semiconducting behavior and 2) the semiconducting behavior degrades as a second order transition at the critical point of the miscibility gaps.

Once the experimental apparatus and experimental methods have been evaluated, the extension of existing predictive capacity to ternary phase diagrams can be sought. Specifically, certain sulfide systems have validated ternary phase diagrams. However, the thermoelectric properties and electronic conductivities of ternary sulfide systems have not been thoroughly investigated (see above). Consequently, the addition of a third component to a binary system affords an ideal opportunity to validate the predictive power of the framework. For some ternary systems, Cu—Ni—S, for example, miscibility gaps are expressed over only a small range of Ni concentration. Thus, by varying the concentration of Ni in the system and monitoring the thermoelectric properties of the system, it is possible to confirm or dispute the hypothesis that a phase-diagram based prediction of the semiconducting properties of the liquid phase is generally valid for sulfide systems and not limited to binary systems.

The framework described herein can be practically useful for fields beyond thermoelectrics if it allows for the incorporation of empirically derived thermoelectric data into a thermodynamic description of the material system. Consequently, the generation of a liquid-state phase diagram of a selected binary material system can be achieved via mapping of the thermoelectric and electrical conductivity behavior of the system over composition and temperature ranges spanning the entire region of interest be attempted. The basic concept is to leverage the connection between the presence of miscibility gaps and semiconducting behavior to determine the boundaries and extrema of the miscibility gaps. For example, a sample at a given composition will be gradually heated across the boundary of a miscibility gap. A discontinuity in the Seebeck coefficient and electronic conductivity will appear as a signal indicating the presence of this boundary.

The accuracy of the generated phase diagram can be confirmed by leveraging Differential Thermal Analysis (DTA), which can confirm the presence and location of critical features of the generated phase diagram including liquidus, critical points, and miscibility gaps.

The capstone goal to demonstrate the utility of thermoelectric measurement in the liquid state as a means to generate predictive thermodynamic information can involve the integration of phase diagram information generated by thermoelectric measurement back into a thermodynamic database. FactSage can be used as the software to build this database for reasons described below. Once the database is generated and optimized, phase diagrams can be generated in FactSage of the system. This can be used to further confirm the thermoelectric and DTA generated phase diagrams.

The above-described research comes with certain challenges and issues. The experiments are at high temperature (e.g., greater than 400° C.) due to the range of melting points of sulfide systems. Further, vapor-phase sulfur is known to evolve from sulfides at high temperature due to high vapor pressures. This may require the experimentalist to provide control over the partial pressures of relevant species in order to ensure the accuracy of the phase diagrams. The temperature ranges and material systems of interest severely limit the containment and probe materials available for use. However, as described above, successful experiments of sulfide systems at high temperature have been performed for decades and can be leveraged towards the existing body of research when designing experimental apparatuses and procedures.

Consequently, information gained can affect the research and several key issues have been identified. The connection between semiconducting properties and the phase diagrams of sulfide systems may be invalid. Thermoelectric and electrical conductivity measurements may be insufficiently accurate or precise to identify phase diagram features. Critical points of miscibility gaps may be inaccessible due to the experimental challenges associated with meeting the thermodynamic conditions required for their presence (i.e. high pressures required to suppress vaporization). The phase diagram information generated may be insufficient to develop thermodynamic databases in FactSage

The first issue can be substantially mitigated by previous research efforts. However, it is of interest in relation to the extension of the framework to multicomponent systems. The determination that this connection is not valid for multicomponent systems would, by itself, be of scientific interest.

The second can also be substantially mitigated by previous research efforts. However, the accuracy and precision of measurement is of course coupled to the design and operation of the experimental apparatus. Should the apparatus be insufficiently precise for the purposes of this investigation, a redesign of experiment must be performed. The ability of previous researchers to achieve sufficient accuracy and precision gives us confidence that this will not be a permanent barrier to progress.

The third issue can be mitigated by selecting a material system to ensure that the thermodynamic conditions required for manifestation of critical points are achievable within the specifications of our experimental apparatus.

Regarding fourth issue, FactSage is actively seeking novel experimental methods to generate phase information for thermodynamic databases and collaborators have expressed interest in partnership on this component of our proposal.

The goal of research includes achieving a phenomenological and theoretical description of semiconducting liquids or, more specifically, thermoelectric sulfides. The results can provide a foundation from which additional research may be performed to validate the framework, and supply practical, usable data to academia and industry. For example, atomistic simulation can serve as a useful tool to detail the chemical foundation of order driving the transitions to map out. Collaboration with atomistic modelers to build a deeper understanding of the mechanisms can help drive research into thermoelectric behavior in the systems of interest.

Further, the identification of a means to predict semiconducting behavior of melts from phase diagram information renews our interest in alternative methods to predict phase diagrams. These may include Monte Carlo simulation, novel cluster (or associate) thermodynamic models, and others.

The tools and methods chosen for this research effort have been selected based on: prior validation in literature, applicability to the material systems of interest, applicability to the thermodynamic conditions of interest, and opportunity for collaboration.

A measurement cell has been developed. A sealed alumina crucible is heated by an inductive coil. An alumina multibore tube bearing graphite electrodes and type K, R, or B thermocouples is fed through a radial seal in the top of the crucible by a Zaber linear stage capable of 10 micron precision. The crucible has a controlled atmosphere, connected to a gas rack with gas flow meters and gas analysis capability. The primary purge gas is argon. The entire system, including the inductive coil, is contained in a sealed secondary containment continuously purged with argon. The induction heater provides a temperature gradient of approximately 3° C. per mm. Conductivity measurements are performed between two electrodes at the same temperature. Seebeck coefficient measurements are performed between two electrodes at different temperatures.

AC and DC electrical conductivity measurements are performed with a Gamry Reference 3000 potentiostat/galvanostat. The system is calibrated with a reference material of known conductivity, such as aluminum or gallium. Seebeck coefficient measurements are performed with a Keithley 2182A nanovoltmeter.

DTA provides a means to monitor changes in the heat capacity and enthalpy of a sample. An inert reference and the sample are heated at the same rate while the temperature is monitored. A difference in temperature reflects a change in heat capacity. Thus, first and second order transitions can be measured by DTA, as demonstrated by Ilatovskaya.

A specific DTA device has not yet been specified. Further, the corrosive nature of sulfide systems may limit the available techniques. Differential Scanning Calorimetry and Drop Calorimetry will be considered as alternatives to DTA.

FactSage is a leading developer of thermodynamic software for the modeling and minimization of Gibbs energy for thermodynamic calculations and generation of phase diagrams. FactSage databases already include numerous industrially-relevant slag systems bearing sulfides. Specifically, copper, iron, and nickel sulfide binary and ternary systems have complete databases and validated phase diagrams. FactSage has implemented the modified quasichemical model of Pelton as the primary Gibbs energy model for the liquid state. CVM has been implemented in select cases. FactSage offers the ability to develop private databases based on experimental data. The development of new FactSage databases for molten sulfides can be collaborated.

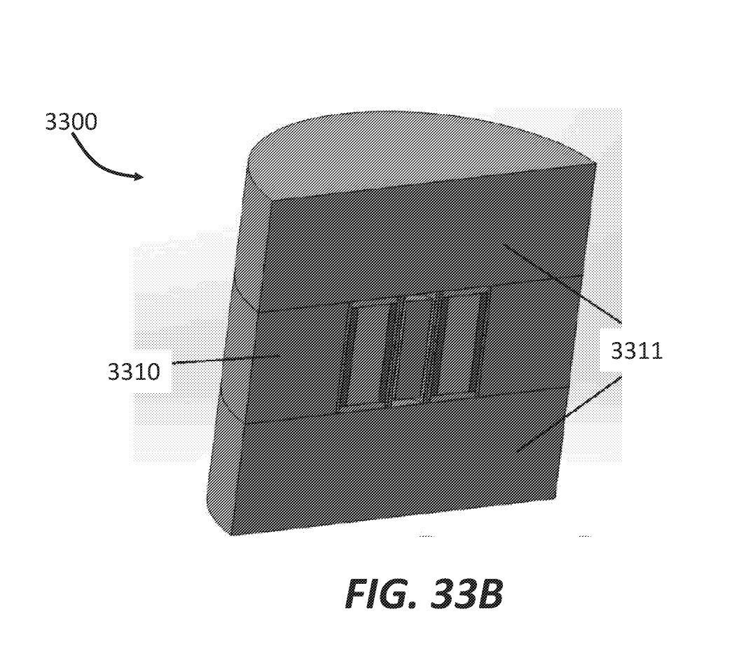

FIGS. 33A and 33B show a schematic of a thermoelectric device 3300. The device 330 includes a heating element 3301 disposed in an inner tube 3303 having an inner metal ring 3302. An inner insulating tube 3304 is disposed outside the inner tube 3303 to separate the inner tube 3303 from a graphite inner wall 3305. Two fused quartz plates 3306 are disposed on the top and bottom of the device 3300. The device 3300 further includes a graphite outer wall 3307, an outer tube 3308 having an outer ring 3309. An outside insulation 3310 is substantially enclosing the device 3300 and two insulation covers 3311 are covering the quartz plates 3306.

In some embodiments, the parameters for the device 3300 can be: the inner and outer diameters of TE d1 and d2 can be about 1.8 cm and 3.8 cm, respectively, the outermost diameter d3 can be about 10 cm, and the height of TE l can be about 3 cm.

In some embodiments, the heating element 3301 can include SiC. In some embodiments, the heating element 3301 can include graphite. In some other embodiments, the heating element can include MoSi₂. In some embodiments, the outside insulation layer 3310 can include ceramic foam.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method, comprising:
contacting a metallic compound comprising a first metallic cation, with a melt comprising a metallic polysulfide comprising a second metallic cation, thereby forming a molten metallic polysulfide of the first metallic cation, then
cooling the melt to form a sulfur phase and a solid phase comprising the molten metallic polysulfide of the first metallic cation.

2. The method of claim 1, wherein the metallic compound comprises a metallic silicate.

3. The method of claim 1, wherein the metallic compound comprises a metallic aluminosilicate.

4. The method of claim 1, wherein the first metallic cation comprises an alkali metal cation.

5. The method of claim 1, wherein the first metallic cation comprises a potassium cation.

6. The method of claim 5, wherein the metallic compound comprises k-feldspar powder.

7. The method of claim 6, wherein the k-feldspar powder comprises a plurality of k-feldspar particles having a particle size substantially equal to or less than 2 mm.

8. The method of claim 5, wherein the metallic compound comprises potassium zeolite.

9. The method of claim 5, wherein the metallic polysulfide comprising the second metallic cation comprises Na₂Sₙ, where n is an integer equal to or greater than 2.

10. The method of claim 5, wherein the metallic polysulfide comprising the first metallic cation comprises K₂Sₙ, wherein n is greater than 2.

11. The method of claim 10, wherein the metallic polysulfide comprising the first metallic cation comprises K₂S₆.

12. The method of claim 11, further comprising:
oxidizing the K₂S₆ to generate K₂SO₄.

13. The method of claim 1, wherein the melt is maintained at a temperature of above 300° C.

14. The method of claim 13, wherein said cooling is to a temperature of less than 300° C.

15. The method of claim 1, wherein the difference between the ionic radius of the first metallic ion and the ionic radius of the second metallic ion is substantially equal to or less than 25% of the ionic radius of the first metallic ion.

16. The method of claim 1, wherein the composition of the melt is within the miscibility gap of the first metallic ion/second metallic ion/sulfur phase diagram.

17. A method, comprising:
contacting a potassium compound comprising a potassium cation, with a melt comprising sodium polysulfide; then
cooling the melt to form a sulfur phase and a phase comprising a potassium polysulfide.

18. The method of claim 17, wherein the potassium compound comprises KAlSi₃O₈.

19. The method of claim 18, wherein the mass fraction of sulfur in the melt is substantially equal to or greater than 50%.

20. The method of claim 18, where the mass ratio between the potassium compound and the sodium sulfide is about 5:1 to about 10:1.

21. The method of claim 17, wherein the potassium polysulfide comprises K₂S₆.

22. The method of claim 21, further comprising:
oxidizing the K₂S₆ to form K₂SO₄.
